(19) United States
(12) Patent Application Publication
(10) Pub. No.: US 2026/0012576 A1
(43) Pub. Date: Jan. 8, 2026

(54) ELECTRONIC DEVICE AND NON-TRANSITORY MACHINE-READABLE MEDIUM FOR DECODING AND/OR ENCODING VIDEO DATA

(71) Applicant: SHARP KABUSHIKI KAISHA, Sakai City (JP)

(72) Inventors: Yi-Hao LIN, New Taipei City (TW); Yu-Chiao YANG, New Taipei City (TW)

(21) Appl. No.: 19/256,595

(22) Filed: Jul. 1, 2025

Related U.S. Application Data
(60) Provisional application No. 63/666,809, filed on Jul. 2, 2024.

(51) Int. Cl. H04N 19/105; H04N 19/159; H04N 19/176; H04N 19/513

(52) U.S. Cl. CPC H04N 19/105; H04N 19/159; H04N 19/176; H04N 19/521

(57) ABSTRACT

A method of decoding and/or encoding video data is provided. The method includes: receiving the video data; determining a block unit from an image frame of the video data; determining a guiding reference vector of the block unit; determining a guided reference block that is indicated by the guiding reference vector of the block unit, the guiding reference vector starting from the block unit; determining a first relocated intra prediction mode based on a first relocated position of the guided reference block, where the first relocated intra prediction mode is one of several most probable mode (MPM) candidates in an MPM list of the block unit; and reconstructing the block unit based on the MPM list of the block unit. Furthermore, an electronic device and a non-transitory machine-readable medium of an electronic device using the aforementioned method are also provided.

### CROSS-REFERENCE TO RELATED APPLICATION(S)

The present disclosure claims the benefit of and priority to U.S. Provisional Patent Application Ser. No. 63/666,809, filed on Jul. 2, 2024, entitled “VECTOR GUIDED CANDIDATE FOR MPM,” the content of which is hereby incorporated herein fully by reference in its entirety for all purposes.

### FIELD

The present disclosure generally relates to video coding, and more specifically, to techniques for predicting a block unit using a most probable mode (MPM) of the block unit, which is determined based on a guiding reference vector of the block unit.

### BACKGROUND

Most probable mode (MPM) is a coding tool for video coding, in which, an encoder and/or a decoder may predict a current block by using one of multiple intra default modes, which is selected from an MPM list.

In addition, the encoder and/or the decoder may create the MPM list, of the current block, which includes multiple MPM candidates. The MPM candidates may be derived or inherited from multiple neighboring blocks, reconstructed prior to the reconstruction of the current block. The neighboring blocks may have, respectively, an intra prediction mode, selected from the intra default modes. The intra prediction modes of the neighboring blocks, however, may be just multiple potential modes for predicting the current block, but not the most appropriate mode. Thus, the intra prediction modes of the neighboring blocks may be inadequate to precisely and efficiently predict all of several samples in the current block.

Thus, MPM refinement mode for deriving the MPM candidates of the current block may be required for the encoder and/or the decoder to be able to precisely and efficiently predict and/or reconstruct the current block.

### SUMMARY

The present disclosure is directed to a non-transitory machine-readable medium and an electronic device for predicting a block unit by using an MPM list, derived based on a guiding reference vector of the block unit.

In a first aspect of the present disclosure, a non-transitory machine-readable medium of an electronic device storing one or more computer-executable instructions for decoding video data is provided. The one or more computer-executable instructions, when executed by at least one processor of the electronic device, cause the electronic device to: receive the video data; determine a block unit from an image frame of the video data; determine a guiding reference vector of the block unit; determine a guided reference block that is indicated by the guiding reference vector of the block unit, the guiding reference vector starting from the block unit; determine a first relocated intra prediction mode based on a first relocated position of the guided reference block, wherein the first relocated intra prediction mode is one of multiple most probable mode (MPM) candidates in an MPM list of the block unit; and reconstruct the block unit based on the MPM list of the block unit.

In an implementation of the first aspect of the present disclosure, determining the guiding reference vector of the block unit comprises: determining multiple guiding reference positions of the block unit; determining a guiding reference unit covering at least one of the multiple guiding reference positions of the block unit; when the guiding reference unit is predicted based on a guiding prediction vector, determining the guiding prediction vector of the guiding reference unit as the guiding reference vector of the block unit, wherein: when the guiding reference unit is predicted based on the image frame of the video data, the guiding prediction vector of the guiding reference unit is a guiding block vector and the guided reference block is included in the image frame, and when the guiding reference unit is predicted based on a reference frame of the block unit, which is included in the video data and different from the image frame of the video data, the guiding prediction vector of the guiding reference unit is a guiding motion vector and the guided reference block is included in the reference frame.

In an implementation of the first aspect of the present disclosure, determining the guided reference block that is indicated by the guiding reference vector of the block unit comprises: determining multiple guiding start positions based on a block location of the block unit; determining a guided candidate block that is indicated by the guiding reference vector of the block unit, the guiding reference vector starting from a specific one of the multiple guiding start positions; when a first relocated reference unit, which covers at least one of multiple first relocated reference positions of the guided candidate block, is predicted based on a first specific one of multiple intra default modes, determining the guided candidate block as the guided reference block of the block unit, wherein the specific one of the multiple intra default modes is set as the first relocated intra prediction mode and is determined as the one of the multiple MPM candidates in the MPM list.

In an implementation of the first aspect of the present disclosure, when a second relocated reference unit, which covers another one of the multiple first relocated reference positions of the guided candidate block, is predicted based on a second specific one of the multiple intra default modes, the second specific one of the multiple intra default modes is set as a second relocated intra prediction mode and is determined as another one of the multiple MPM candidates in the MPM list.

In an implementation of the first aspect of the present disclosure, the one or more computer-executable instructions, when executed by at least one processor of the electronic device, further cause the electronic device to: when each relocated reference unit, covering any one of the multiple first relocated reference positions of the guided candidate block, is not predicted based on any one of the multiple intra default modes, determine another guided candidate block that is indicated by the guiding reference vector of the block unit, the guiding reference vector starting from a next one of the multiple guiding start positions ordered after the specific one of the multiple guiding start positions.

In an implementation of the first aspect of the present disclosure, the one or more computer-executable instructions, when executed by at least one processor of the electronic device, further cause the electronic device to: determine a first relocated reference vector based on a second relocated position of the guided reference block; determine a first relocated reference block that is indicated by the first relocated reference vector that starts from the guided reference block; determine a second relocated intra prediction mode based on a first relocated position of the first relocated reference block; and determine the second relocated intra prediction mode as one of the multiple MPM candidates in the MPM list of the block unit.

In an implementation of the first aspect of the present disclosure, wherein the one or more computer-executable instructions, when executed by at least one processor of the electronic device, further cause the electronic device to: determine an N-th relocated reference vector based on a relocated position of an (N−1)-th relocated reference block, N being an integer; determine an N-th relocated reference block that is indicated by the N-th relocated reference vector that starts from the (N−1)-th relocated reference block, wherein the number N indicates a relocated level of the N-th relocated reference block; determine at least one relocated reference unit of the N-th relocated reference block; determine whether the at least one relocated reference unit of the N-th relocated reference block is reconstructed by a specific one of multiple intra default modes for adding into the MPM list of the block unit; and forgo determining whether the at least one relocated reference unit of the N-th relocated reference block is reconstructed by a vector prediction mode when the relocated level of the N-th relocated reference block equal to N is equal to a relocated level threshold.

In a second aspect of the present disclosure, an electronic device for decoding video data is provided. The electronic device includes at least one processor and one or more non-transitory computer-readable media that are coupled to the at least one processor. The one or more non-transitory computer-readable media store one or more computer-executable instructions that, when executed by the at least one processor, cause the electronic device to: receive the video data; determine a block unit from an image frame of the video data; determine a guiding reference vector of the block unit; determine a guided reference block that is indicated by the guiding reference vector of the block unit, the guiding reference vector starting from the block unit; determine a first relocated intra prediction mode based on a first relocated position of the guided reference block, wherein the first relocated intra prediction mode is one of multiple most probable mode (MPM) candidates in an MPM list of the block unit; and reconstruct the block unit based on the MPM list of the block unit.

In an implementation of the second aspect of the present disclosure, determining the guiding reference vector of the block unit comprises: determining multiple guiding reference positions of the block unit; determining a guiding reference unit covering at least one of the multiple guiding reference positions of the block unit; when the guiding reference unit is predicted based on a guiding prediction vector, determining the guiding prediction vector of the guiding reference unit as the guiding reference vector of the block unit, wherein: when the guiding reference unit is predicted based on the image frame of the video data, the guiding prediction vector of the guiding reference unit is a guiding block vector and the guided reference block is included in the image frame, and when the guiding reference unit is predicted based on a reference frame of the block unit, which is included in the video data and different from the image frame of the video data, the guiding prediction vector of the guiding reference unit is a guiding motion vector and the guided reference block is included in the reference frame.

In an implementation of the second aspect of the present disclosure, determining the guided reference block that is indicated by the guiding reference vector of the block unit comprises: determining multiple guiding start positions based on a block location of the block unit; determining a guided candidate block that is indicated by the guiding reference vector of the block unit, the guiding reference vector starting from a specific one of the multiple guiding start positions; when a first relocated reference unit, which covers at least one of multiple first relocated reference positions of the guided candidate block, is predicted based on a first specific one of multiple intra default modes, determining the guided candidate block as the guided reference block of the block unit, wherein the specific one of the multiple intra default modes is set as the first relocated intra prediction mode and is determined as the one of the multiple MPM candidates in the MPM list.

In an implementation of the second aspect of the present disclosure, when a second relocated reference unit, which covers another one of the multiple first relocated reference positions of the guided candidate block, is predicted based on a second specific one of the multiple intra default modes, the second specific one of the multiple intra default modes is set as a second relocated intra prediction mode and is determined as another one of the multiple MPM candidates in the MPM list.

In an implementation of the second aspect of the present disclosure, the one or more computer-executable instructions, when executed by at least one processor of the electronic device, further cause the electronic device to: when each relocated reference unit, covering any one of the multiple first relocated reference positions of the guided candidate block, is not predicted based on any one of the multiple intra default modes, determine another guided candidate block that is indicated by the guiding reference vector of the block unit, the guiding reference vector starting from a next one of the multiple guiding start positions ordered after the specific one of the multiple guiding start positions.

In an implementation of the second aspect of the present disclosure, the one or more computer-executable instructions, when executed by at least one processor of the electronic device, further cause the electronic device to: determine a first relocated reference vector based on a second relocated position of the guided reference block; determine a first relocated reference block that is indicated by the first relocated reference vector that starts from the guided reference block; determine a second relocated intra prediction mode based on a first relocated position of the first relocated reference block; and determine the second relocated intra prediction mode as one of the multiple MPM candidates in the MPM list of the block unit.

In an implementation of the second aspect of the present disclosure, wherein the one or more computer-executable instructions, when executed by at least one processor of the electronic device, further cause the electronic device to: determine an N-th relocated reference vector based on a relocated position of an (N−1)-th relocated reference block, N being an integer; determine an N-th relocated reference block that is indicated by the N-th relocated reference vector that starts from the (N−1)-th relocated reference block, wherein the number N indicates a relocated level of the N-th relocated reference block; determine at least one relocated reference unit of the N-th relocated reference block; determine whether the at least one relocated reference unit of the N-th relocated reference block is reconstructed by a specific one of multiple intra default modes for adding into the MPM list of the block unit; and forgo determining whether the at least one relocated reference unit of the N-th relocated reference block is reconstructed by a vector prediction mode when the relocated level of the N-th relocated reference block equal to N is equal to a relocated level threshold.

In a third aspect of the present disclosure, an electronic device for encoding video data is provided. The electronic device includes at least one processor and one or more non-transitory computer-readable media that are coupled to the at least one processor. The one or more non-transitory computer-readable media store one or more computer-executable instructions that, when executed by the at least one processor, cause the electronic device to: receive the video data; determine a block unit from an image frame of the video data; determine a guiding reference vector of the block unit; determine a guided reference block that is indicated by the guiding reference vector of the block unit, the guiding reference vector starting from the block unit; determine a first relocated intra prediction mode based on a first relocated position of the guided reference block, wherein the first relocated intra prediction mode is one of multiple most probable mode (MPM) candidates in an MPM list of the block unit; and reconstruct the block unit based on the MPM list of the block unit.

In an implementation of the third aspect of the present disclosure, determining the guiding reference vector of the block unit comprises: determining multiple guiding reference positions of the block unit; determining a guiding reference unit covering at least one of the multiple guiding reference positions of the block unit; when the guiding reference unit is predicted based on a guiding prediction vector, determining the guiding prediction vector of the guiding reference unit as the guiding reference vector of the block unit, wherein: when the guiding reference unit is predicted based on the image frame of the video data, the guiding prediction vector of the guiding reference unit is a guiding block vector and the guided reference block is included in the image frame, and when the guiding reference unit is predicted based on a reference frame of the block unit, which is included in the video data and different from the image frame of the video data, the guiding prediction vector of the guiding reference unit is a guiding motion vector and the guided reference block is included in the reference frame.

In an implementation of the third aspect of the present disclosure, determining the guided reference block that is indicated by the guiding reference vector of the block unit comprises: determining multiple guiding start positions based on a block location of the block unit; determining a guided candidate block that is indicated by the guiding reference vector of the block unit, the guiding reference vector starting from a specific one of the multiple guiding start positions; when a first relocated reference unit, which covers at least one of multiple first relocated reference positions of the guided candidate block, is predicted based on a first specific one of multiple intra default modes, determining the guided candidate block as the guided reference block of the block unit, wherein the specific one of the multiple intra default modes is set as the first relocated intra prediction mode and is determined as the one of the multiple MPM candidates in the MPM list.

In an implementation of the third aspect of the present disclosure, when a second relocated reference unit, which covers another one of the multiple first relocated reference positions of the guided candidate block, is predicted based on a second specific one of the multiple intra default modes, the second specific one of the multiple intra default modes is set as a second relocated intra prediction mode and is determined as another one of the multiple MPM candidates in the MPM list.

In an implementation of the third aspect of the present disclosure, the one or more computer-executable instructions, when executed by at least one processor of the electronic device, further cause the electronic device to: when each relocated reference unit, covering any one of the multiple first relocated reference positions of the guided candidate block, is not predicted based on any one of the multiple intra default modes, determine another guided candidate block that is indicated by the guiding reference vector of the block unit, the guiding reference vector starting from a next one of the multiple guiding start positions ordered after the specific one of the multiple guiding start positions.

In an implementation of the third aspect of the present disclosure, the one or more computer-executable instructions, when executed by at least one processor of the electronic device, further cause the electronic device to: determine a first relocated reference vector based on a second relocated position of the guided reference block; determine a first relocated reference block that is indicated by the first relocated reference vector that starts from the guided reference block; determine a second relocated intra prediction mode based on a first relocated position of the first relocated reference block; and determine the second relocated intra prediction mode as one of the multiple MPM candidates in the MPM list of the block unit.

In an implementation of the third aspect of the present disclosure, wherein the one or more computer-executable instructions, when executed by at least one processor of the electronic device, further cause the electronic device to: determine an N-th relocated reference vector based on a relocated position of an (N−1)-th relocated reference block, N being an integer; determine an N-th relocated reference block that is indicated by the N-th relocated reference vector that starts from the (N−1)-th relocated reference block, wherein the number N indicates a relocated level of the N-th relocated reference block; determine at least one relocated reference unit of the N-th relocated reference block; determine whether the at least one relocated reference unit of the N-th relocated reference block is reconstructed by a specific one of multiple intra default modes for adding into the MPM list of the block unit; and forgo determining whether the at least one relocated reference unit of the N-th relocated reference block is reconstructed by a vector prediction mode when the relocated level of the N-th relocated reference block equal to N is equal to a relocated level threshold.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIGS. 4A-4C are schematic diagrams illustrating different guided candidate blocks that are indicated by the guiding reference vectors having the same magnitude and starting from different guiding start positions, in accordance with one or more example implementations of this disclosure.

FIGS. 5A and 5B are schematic diagrams illustrating different first relocated reference blocks that are indicated by the first relocated reference vectors having the same magnitude and starting from different first relocated start positions, in accordance with one or more example implementations of this disclosure.

FIG. 6 is a schematic diagram illustrating multiple relocated reference blocks that are indicated by multiple relocated reference vectors and that are in different relocated levels, in accordance with one or more example implementations of this disclosure.

FIG. 7 is another schematic diagram illustrating multiple relocated reference blocks that are indicated by multiple relocated reference vectors and that are in different relocated levels, in accordance with one or more example implementations of this disclosure.

FIG. 8 is a block diagram illustrating an encoder module of the first electronic device illustrated in FIG. 1, in accordance with one or more example implementations of this disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

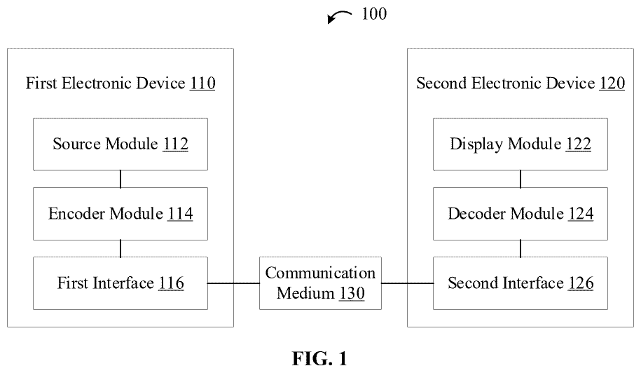

FIG. 1 is a block diagram illustrating a system 100 having a first electronic device and a second electronic device for encoding and decoding video data, in accordance with one or more example implementations of this disclosure.

The system 100 may include a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and/or the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

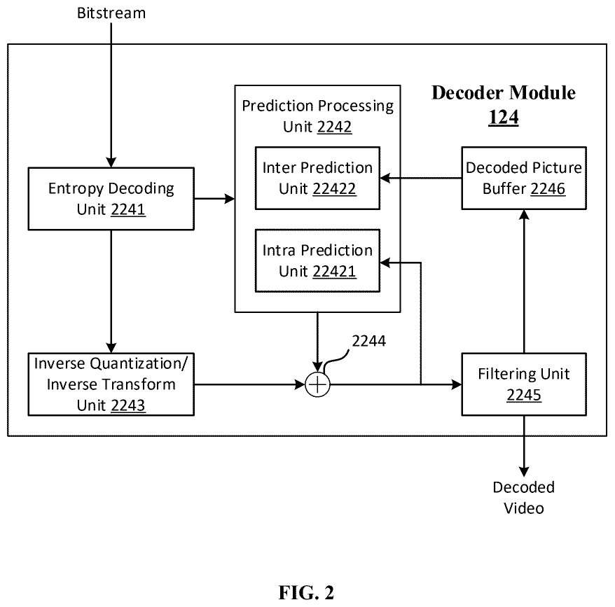

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames based on the partition information.

Each of the image frames may be divided into at least one image block based on the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame, as the current block unit, based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components are reconstructed by using the prediction processing unit 2242.

The intra prediction unit 22421 may reconstruct multiple chroma components of the current block unit based on the multiple luma components of the current block unit when the multiple luma components of the current block unit are reconstructed by using the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (are not explicitly illustrated for brevity of the description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

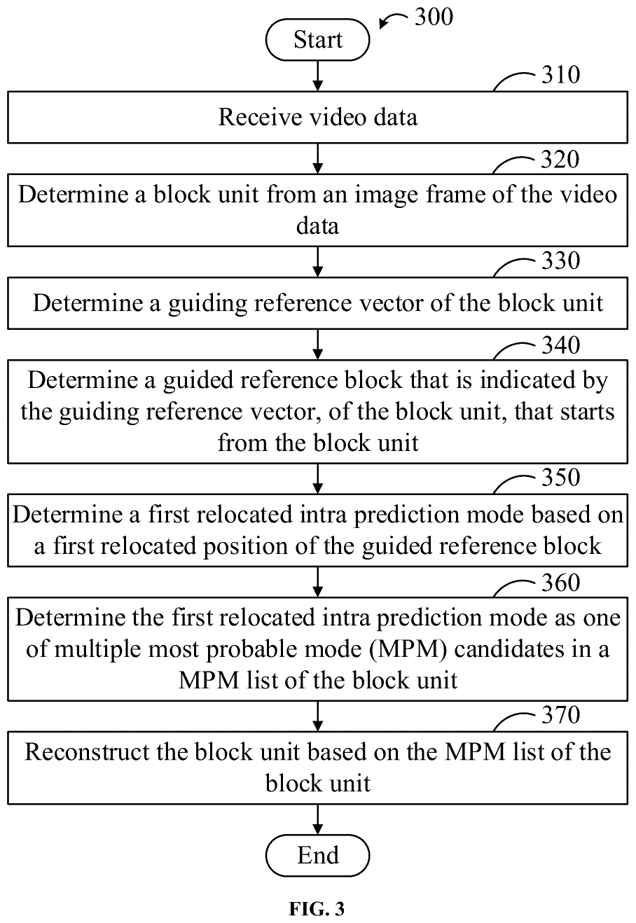

FIG. 3 is a flowchart illustrating a method/process 300 for decoding and/or encoding video data by an electronic device, in accordance with one or more example implementations of this disclosure. The method/process 300 is an example implementation, as there may be a variety of mechanisms of decoding the video data.

The method/process 300 may be performed by an electronic device using the configurations illustrated in FIGS. 1 and/or 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus the order may be different from what is illustrated. Additional blocks may be added or fewer blocks may be utilized without departing from the scope of the present disclosure.

At block 310, the method/process 300 may start by receiving (e.g., via the decoder module 124, as shown in FIG. 2) the video data. The video data received by the decoder module 124 may include a bitstream.

With reference to FIGS. 1 and 2, the second electronic device 120 may receive the bitstream from an encoder, such as the first electronic device 110 (or other video providers), via the second interface 126.

At block 320, the decoder module 124 may determine a block unit from an image frame of the video data.

With reference to FIGS. 1 and 2, the decoder module 124 may determine the image frames included in the bitstream when the video data, received by the decoder module 124, includes the bitstream. The current frame may be one of the image frames, determined based on the bitstream. The decoder module 124 may further divide the current frame to determine the block unit, based on the partition indications in the bitstream. In some implementations, the decoder module 124 may divide the current frame to generate multiple CTUs, and may further divide a current CTU, included in the CTUs, to generate multiple divided blocks and to determine a block unit from the divided blocks, based on the partition indications (e.g., based on any video coding standard).

In some other implementations, the decoder module 124 may divide the current frame to generate multiple slices or multiple tiles, and further divide a current slice or a current tile, included in the slices or the tiles, to generate multiple CTUs. In addition, the decoder module 124 may further divide a current CTU, included in the CTUs, to generate multiple divided blocks and to determine the block unit from the divided blocks, based on the partition indications.

The size of the block unit may be Wb×Hb. In some implementations, each of the Wb and Hb may be a positive integer (e.g., four, eight, etc.) that may be the same, or different from the other.

At block 330, the decoder module 124 may determine a guiding reference vector of the block unit.

The guiding reference vector may be determined based on one of a guiding block vector and a guiding motion vector. In some implementations, the guiding block vector may be a guiding prediction vector of a guiding reference unit, predicted based on the image frame of the video data. In addition, the guiding block vector may be the guiding prediction vector, of the guiding reference unit, generated by using an intra block copy (IBC) mode, an intra template matching prediction (intraTMP) mode, or a spatial geometric partition mode (SGPM) of a video coding standard, including a Versatile Video Coding (VVC) standard. In some other implementations, the guiding motion vector may be the guiding prediction vector of the guiding reference unit, predicted based on a reference frame of the block unit. In some implementations, the reference frame of the block unit may be included in the video data and may be different from the image frame of the video data. In addition, the guiding motion vector may be the guiding prediction vector, of the guiding reference unit, generated by using an inter prediction mode of the video coding standard.

In some implementations, the decoder module 124 may determine multiple guiding reference positions of the block unit. The guiding reference unit may cover one or more of the guiding reference positions of the block unit. When the guiding reference unit is predicted by using the guiding prediction vector, the guiding prediction vector of the guiding reference unit may be determined as the guiding reference vector of the block unit. In some implementations, the guiding reference positions may include multiple adjacent guiding positions and non-adjacent guiding positions.

In some implementations, multiple adjacent guiding units, may cover one or more of the adjacent guiding positions, respectively. The number of adjacent guiding positions may be equal to, or greater than, one. For example, when the number of adjacent guiding positions is equal to five, the adjacent guiding positions may include a first adjacent guiding position, located above a top-right corner of the block unit, a second adjacent guiding position, located at a left side of a bottom-left corner of the block unit, a third adjacent guiding position, located at a top-right side of the top-right corner of the block unit, a fourth adjacent guiding position, located at a top-left side of a top-left corner of the block unit, and a fifth adjacent guiding position, located at a bottom-left side of a bottom-left corner of the block unit. For example, when the coordinates of the block unit in the image frame are represented as (x, y), the coordinates of the above-described five adjacent guiding positions may be represented, respectively, as (x+Wb−1, y−1), (x−1, y+Hb−1), (x+Wb, y−1), (x−1, y+Hb), and (x−1, y−1).

When a specific one of the adjacent guiding units, which covers one or more of the adjacent guiding positions, is predicted based on an adjacent guiding vector, the adjacent guiding vector of the specific adjacent guiding unit may be regarded as a guiding reference vector of the guiding reference unit.

In some implementations, multiple non-adjacent guiding units, may cover one or more of the non-adjacent guiding positions, respectively. The number of non-adjacent guiding positions may be greater than one. In some implementations, the non-adjacent guiding positions may be identical to multiple inter non-adjacent positions in an inter merge mode of the video coding standard. In some implementations, the non-adjacent guiding positions may include the first N ones of the inter non-adjacent positions in the inter merge mode of the video coding standard. In some implementations, the number N may be a positive integer. Thus, the number of non-adjacent guiding positions may be less than, or equal to, the number of inter non-adjacent positions in the inter merge mode of the video coding standard.

When a specific one of the non-adjacent guiding units, which covers one or more of the non-adjacent guiding positions, is predicted based on a non-adjacent guiding vector, the non-adjacent guiding vector of the specific non-adjacent guiding unit may be a guiding reference vector of the guiding reference unit.

In some implementations, the guiding reference unit may be predicted based on the image frame of the video data. Thus, the guiding prediction vector of the guiding reference unit may be the guiding block vector. In some other implementations, the guiding reference unit may be predicted based on the reference frame of the block unit. Thus, the guiding prediction vector of the guiding reference unit may be the guiding motion vector.

The reference frame may be included in multiple reference picture lists in an inter prediction mode of the video coding standard. The reference picture lists may include a first reference picture list (L0) and a second reference picture list (L1). In addition, the first reference picture list (L0) may include multiple first reference frames, and the second reference picture list (L1) may include multiple second reference frames. In some implementations, the first reference frames in the first reference picture list (L0) may be different from the second reference frames in the second reference picture list (L1), or the first reference frames in the first reference picture list (L0) may be partly identical to the second reference frames in the second reference picture list (L1).

Referring back to FIG. 3, at block 340, the decoder module 124 may determine a guided reference block that is indicated by the guiding reference vector, of the block unit, that starts from the block unit.

In some implementations, when the guiding reference unit is predicted based on the image frame in the video data, the guided reference block, indicated by the guiding block vector, may be included in the image frame. In some other implementations, when the guiding reference unit is predicted based on the reference frame of the block unit, the guided reference block, indicated by the guiding motion vector, may be included in the reference frame.

When the decoder module 124 determines the guided reference block, indicated by the guiding reference vector of the block unit, the decoder module 124 may first determine multiple guided candidate blocks, each of which may be indicated by the guiding reference vector of the block unit. The decoder module 124 may then determine whether the guided candidate blocks is to be selected as the guided reference blocks.

The decoder module 124 may determine multiple guiding start positions based on a block location of the block unit. The guided candidate block may be indicated by the guiding reference vector, of the block unit, that starts from one of multiple guiding start positions of the block unit to one of multiple guiding end positions for determining the guided reference block.

The guiding start positions may be predefined in the first electronic device 110 and/or the second electronic device 120. The number of guiding start positions may be equal to, or greater than, one. For example, when the number of guiding start positions is equal to five, the guiding start positions may include a first guiding start position C1, located at the center position of the block unit, a second guiding start position AL1, located at the top-left corner of the block unit, a third guiding start position AR1, located at the top-right corner of the block unit, a fourth guiding start position BL1, located at the bottom-left corner of the block unit, and a fifth guiding start position BR1, located at a bottom-right corner of the block unit. For example, when the coordinates of the block unit in the image frame are (x, y), the coordinates of the five guiding start positions may, respectively, be C1 (x+((Wb−1)/2), y+((Hb−1)/2)), AL1 (x, y), AR1 (x+Wb−1, y), BL1 (x, y+Hb−1), and BR1 (x+Wb−1, y+Hb−1). In some other implementations, the coordinates of the five guiding start positions may, respectively, be C1 (x+(Wb/2), y+(Hb/2)), AL1 (x, y), AR1 (x+Wb−1, y), BL1 (x, y+Hb−1), and BR1 (x+Wb−1, y+Hb−1).

In some implementations, a search order of the guiding start positions for determining the guided reference block may be predefined in the first electronic device 110 and/or the second electronic device 120. For example, the guiding start positions for determining the guided reference block may be sequentially ordered from the first guiding start position to the last guiding start position. In some implementations, when the number of guiding start positions is equal to five, the search order of the five guiding start positions, e.g., C1, AL1, AR1, BL1, and BR1, for determining the guided reference block may be sequentially arranged as C1, AL1, AR1, BL1, and BR1. In some other implementations, when the number of guiding start positions is equal to three, the search order of the three guiding start positions, e.g., C1, AL1, and BR1, for determining the guided reference block may be sequentially arranged as C1, AL1, and BR1.

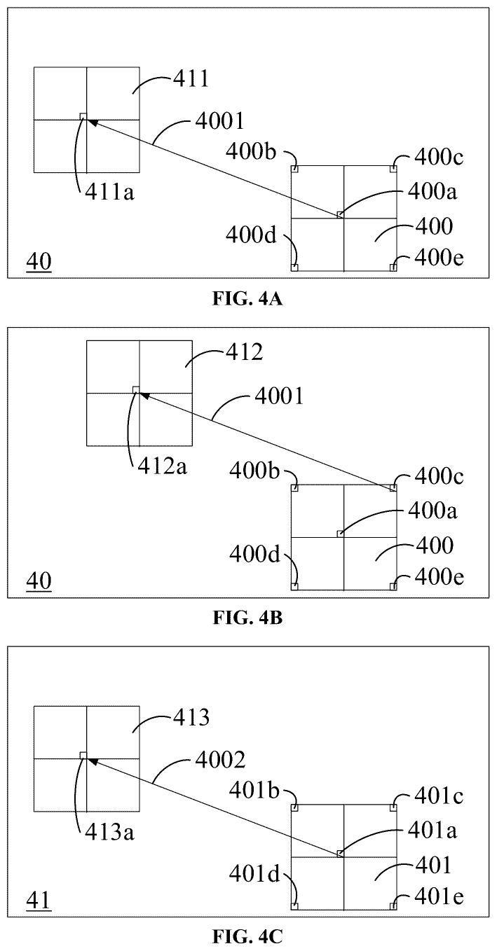

FIGS. 4A-4C are schematic diagrams illustrating different guided candidate blocks that are indicated by the guiding reference vectors having the same magnitude and starting from different guiding start positions, in accordance with one or more example implementations of this disclosure.

FIG. 4A illustrates the guided candidate block 411 that is indicated by the guiding reference vector 4001, of the block unit 400, that starts from the guiding start position 400a of the block unit 400 to the guiding end position 411a. In FIG. 4A, the guiding reference vector 4001 may be the guiding block vector that is indicates the guided candidate block 411 and that is included in an image frame 40. Thus, both the block unit 400 and the guided candidate block 411 may be included in the image frame 40.

The block unit 400 may cover the first guiding start position 400a, the second guiding start position 400b, the third guiding start position 400c, the fourth guiding start position 400d, and the fifth guiding start position 400c. In order to determine the guided candidate block 411, the decoder module 124 may select one of the guiding start positions 400a-400e, as a starting point of the guiding reference vector 4001. For example, in FIG. 4A, the starting point of the guiding reference vector 4001 may be the first guiding start position 400a for determining the guided candidate block 411.

The guiding end position may be included in the guided candidate block. A size of the guided candidate block may be identical to the size Wb×Hb of the block unit. The location of the guided candidate block may be determined based on the size Wb×Hb of the block unit and the spatial relationship between the guiding end position and the guided candidate block. A method for determining the spatial relationship between the guiding end position and the guided candidate block may be predefined in the first electronic device 110 and/or the second electronic device 120.

In some implementations, the guiding end position may be predefined, as a center position of the guided candidate block. Thus, the guiding end position may be first determined by using the guiding reference vector and the guiding start position of the block unit. The guided candidate block may then be determined by uniformly extending a block from the guiding end position in all directions to generate an intermediate block that has the same size, as the block unit. The intermediate block, covering the guiding end position, which is located at a center position of the intermediate block, may be regarded as the guided candidate block. For example, the guiding end position 411a may be first determined based on the guiding reference vector 4001 and the guiding start position 400a of the block unit 400. Since the guiding end position 411a is predefined to be located at the center position of the guided candidate block 411, the decoder module 124 may uniformly extend a block from the guiding end position 411a in all directions to generate the guided candidate block 411. In addition, the guided candidate block 411 may have the same size, as the block unit 400.

FIG. 4B illustrates the guided candidate block 412 that is indicated by the guiding reference vector 4001, of the block unit 400, that starts from the guiding start position 400c of the block unit 400 to the guiding end position 412a. In FIG. 4B, the guiding reference vector 4001 may be the guiding block vector that indicates the guided candidate block 412 and that is included in the image frame 40. Thus, both the block unit 400 and the guided candidate block 412 may be included in the image frame 40.

In order to determine the guided candidate block 412, the decoder module 124 may select one of the guiding start positions 400a-400e, as the starting point of the guiding reference vector 4001. For example, in FIG. 4B, the starting point of the guiding reference vector 4001 may be the third guiding start position 400c, for determining the guided candidate block 412. The guiding end position 412a may be first determined based on the guiding reference vector 4001 and the guiding start position 400c of the block unit 400. Since the guiding end position 412a is predefined to be located at the center position of the guided candidate block 412, the decoder module 124 may uniformly extend a block from the guiding end position 412a in all directions to generate the guided candidate block 412. In addition, the guided candidate block 412 may have the same size, as the block unit 400.

FIG. 4C illustrates the guided candidate block 413 that is indicated by the guiding reference vector 4002, of the block unit 400, that starts from the guiding start position 401a of a collocated block 401 to the guiding end position 413a. In FIG. 4C, the guiding reference vector 4002 may be the guiding motion vector that indicates the guided candidate block 413 and that is included in a reference frame 41. Thus, the block unit 400 and the guided candidate block 413 may be included in different frames of the video data. In some implementations, the collocated block 401 may be collocated with the block unit 400. Thus, the spatial relationship between the block unit 400 and the image frame 40 in FIG. 4A may be identical to the spatial relationship between the collocated block 401 and the reference frame 41 in the FIG. 4C.

In order to determine the guided candidate block 413, the decoder module 124 may select one of the guiding start positions 401-401e, of the collocated block 401, as the starting point of the guiding reference vector 4002. For example, in FIG. 4C, the starting point of the guiding reference vector 4002 may be the first guiding start position 401a, located at the center position of the collocated block 401, for determining the guided candidate block 413. The guiding end position 413a may be first determined based on the guiding reference vector 4002 and the guiding start position 401a of the collocated block 401. Since the guiding end position 413a is predefined to be located at the center position of the guided candidate block 413, the decoder module 124 may uniformly extend a block from the guiding end position 413a in all directions to generate the guided candidate block 413. In addition, the guided candidate block 413 may have the same size, as the block unit 400.

Since the collocated block 401 in the reference frame 41 is a block that is collocated with the block unit 400 in the image frame 40, the collocated block 401 may be different from the block unit 400. In some implementations, a vector direction and a vector magnitude of the guiding reference vector 4001 in FIG. 4A may be identical to, or different from, a vector direction and a vector magnitude of the guiding reference vector 4002 in FIG. 4C. However, the guided candidate block 411, indicated by the guiding reference vector 4001 and included in the image frame 40, may be different from the guided candidate block 4131 that is indicated by the guiding reference vector 4002 and included in the reference frame 41.

In some implementations, the decoder module 124 may determine a specific one of the guided candidate blocks based on a specific one of the guiding start positions. The specific guided candidate block may be indicated by the guiding reference vector, of the block unit, that starts from the specific guiding start position. The decoder module 124 may then further determine one or more first relocated reference units, each of which may be associated with the specific guided candidate block. Each of the one or more first relocated reference units may partly or fully cover the specific guided candidate block.

The decoder module 124 may determine multiple first relocated reference positions in the specific guided candidate block. The number of first relocated reference positions in the specific guided candidate block may be equal to, or greater than, one. For example, when the number of first relocated reference positions in the specific guided candidate block is equal to five, the first relocated reference positions in the specific guided candidate block may include a relocated reference position C2, located at a center position of the specific guided candidate block, a relocated reference position AL2, located at a top-left corner of the specific guided candidate block, a relocated reference position AR2, located at a top-right corner of the specific guided candidate block, a relocated reference position BL2, located at a bottom-left corner of the specific guided candidate block, and a relocated reference position BR2, located at a bottom-right corner of the specific guided candidate block. For example, when the coordinates of the specific guided candidate block in the image frame or the reference frame is (a, b), the coordinates of the five first relocated reference positions may, respectively, be C2 (a+((Wb−1)/2), b+((Hb−1)/2)), AL2 (a, b), AR2 (a+Wb−1, b), BL2 (a, b+Hb−1), and BR2 (a+Wb−1, b+Hb−1). In some other implementations, the coordinates of the five first relocated reference positions may, respectively, be C2 (a+(Wb/2), b+(Hb/2)), AL2 (a, b), AR2 (a+Wb−1, b), BL2 (a, b+Hb−1), and BR2 (a+Wb−1, b+Hb−1).

In some implementations, a search order of the first relocated reference positions for determining the guided reference block may be predefined in the first electronic device 110 and/or the second electronic device 120. For example, when the number of first relocated reference positions is equal to five, the five first relocated reference positions for determining the guided reference block may be sequentially ordered from the relocated reference position C2 to the relocated reference position BR2. In other words, the search order of the first relocated reference positions for determining the guided reference block may be sequentially arranged, as C2, AL2, AR2, BL2, and BR2.

Since the one or more first relocated reference units are reconstructed prior to the reconstruction of the block unit, the decoder module 124 may determine one or more first relocated prediction modes of the one or more first relocated reference units. Each of the one or more first relocated reference units may be predicted and/or reconstructed, respectively, by using a corresponding one of the one or more first relocated prediction modes. Each of the one or more first relocated prediction modes may be one of an intraTMP mode, an IBC mode, an SGPM mode, one of multiple intra default modes, and an inter prediction mode. The intra default modes may include a Planar mode, a DC mode, and multiple intra directional modes.

In some implementations, when any one of the one or more first relocated reference units, which covers one or more of the first relocated reference positions of the specific guided candidate block, is predicted based on one of the intra default modes, the specific guided candidate block may be regarded, as the guiding reference block of the block unit. In some other implementations, each of the one or more first relocated reference units of the guided candidate block may not be predicted based on any one of the intra default modes. Thus, in order to determine the guided reference block, the decoder module 124 may determine another guided candidate block that is indicated by the guiding reference vector, of the block unit, that starts from a next one of the guiding start positions ordered after the specific guiding start position.

In some implementations, when any one of the one or more first relocated reference units, which covers one or more of the first relocated reference positions of the specific guided candidate block, is predicted based on one of the intra default modes, the specific guided candidate block may be regarded, as the guiding reference block of the block unit. In some other implementations, when any one of the one or more first relocated reference units, which covers one or more of the first relocated reference positions of the specific guided candidate block, is predicted based on one of the intraTMP mode, the IBC mode, an SGPM mode, and the inter prediction mode, an block vector or an motion vector of the first relocated reference unit may be further used to determining the guiding reference block. In yet some other implementations, each of the one or more first relocated reference units of the guided candidate block may be predicted based on a prediction mode without the intra default modes, the block vector, and the motion vector. Thus, in order to determine the guided reference block, the decoder module 124 may determine another guided candidate block that is indicated by the guiding reference vector, of the block unit, that starts from a next one of the guiding start positions ordered after the specific guiding start position.

Referring back to FIG. 3, at block 350, the decoder module 124 may determine a first relocated intra prediction mode based on a first relocated position of the guided reference block.

When a first relocated unit of the first relocated reference units, which covers one or more of the first relocated reference positions of the guided candidate block, is predicted and/or reconstructed by using a first specific one of the intra default modes, the first specific intra default mode may be set, as the first relocated intra prediction mode. The one or more of first relocated reference positions, of the guided candidate block, which correspond to the first relocated unit, may include the first relocated position of the guided reference block. Thus, the first relocated intra prediction mode may be determined based on the first relocated position of the guided reference block. The first relocated intra prediction mode of the first relocated unit may be used to predict the block unit.

In some implementations, when the first specific intra default mode is the Planar mode, the first specific intra default mode may not be set, as the first relocated intra prediction mode. In some other implementations, when the first specific intra default mode is the Planar mode, the first specific intra default mode may be set, as the first relocated intra prediction mode. In some implementations, when the first specific intra default mode is the DC mode, the first specific intra default mode may not be set, as the first relocated intra prediction mode. In some other implementations, when the first specific intra default mode is the DC mode, the first specific intra default mode may be set, as the first relocated intra prediction mode.

When a second relocated unit of the first relocated reference units, which covers one or more of the first relocated reference positions, is predicted and/or reconstructed by using a second specific one of the intra default modes, the second specific intra default mode may be set, as the second relocated intra prediction mode. The one or more of first relocated reference positions, of the guided candidate block, which correspond to the second relocated unit, may include a second relocated position of the guided reference block. Thus, the second relocated intra prediction mode may be determined based on the second relocated position of the guided reference block. The second relocated intra prediction mode of the second relocated unit may be used to predict the block unit.

In some implementations, when the second specific intra default mode is identical to the first specific intra default mode, the second specific intra default mode may not be set, as the second relocated intra prediction mode. In addition, when the second specific intra default mode is different from the first specific intra default mode, the second specific intra default mode may be set, as the second relocated intra prediction mode. In some other implementations, when the second specific intra default mode is identical to, or different from, the first specific intra default mode, the second specific intra default mode may be set, as the second relocated intra prediction mode.

When a third relocated unit of the first relocated reference units, which covers one or more of the first relocated reference positions, is predicted and/or reconstructed by using one of a block vector prediction mode or a motion vector prediction mode, the third relocated unit may be reconstructed by using a first relocated reference vector. The one or more of first relocated reference positions, of the guided candidate block, which correspond to the third relocated unit, may include a third relocated position of the guided reference block. Thus, the first relocated reference vector may be determined based on the third relocated position of the guided reference block. The first relocated reference vector may be used to determine a first relocated reference block that is indicated by the first relocated reference vector that starts from the guided reference block.

In some implementations, the block vector prediction mode may include the IBC mode, the intraTMP mode, and the SGPM mode. When the third relocated unit is predicted and/or reconstructed by using the block vector prediction mode, the first relocated reference vector may be a first relocated block vector. In some other implementations, the motion vector prediction mode may include the inter prediction mode of the video coding standard. When the third relocated unit is predicted and/or reconstructed by using the motion vector prediction mode, the first relocated reference vector may be a first relocated motion vector.

In some implementations, the first to the third relocated units may be different from each other. In some implementations, the one or more of first relocated reference positions, corresponding to the second relocated unit, may be different from the one or more of first relocated reference positions, corresponding to the first relocated unit. In addition, the one or more of first relocated reference positions, corresponding to the third relocated unit, may be different from the one or more of first relocated reference positions, corresponding to the first relocated unit. The one or more of first relocated reference positions, corresponding to the third relocated unit, may be different from the one or more of first relocated reference positions, corresponding to the second relocated unit.

The first relocated reference block may be indicated by the first relocated reference vector, of the third relocated unit, that starts from a first relocated start position in the guided reference block to a first relocated end position in the first relocated reference block. The method for determining the first relocated start position in the guided reference block may be predefined in the first electronic device 110 and/or the second electronic device 120.

When the decoder module 124 determines the first relocated reference block, the decoder module 124 may select one of multiple first relocated start positions, as a starting point of the first relocated reference vector, to indicate the first relocated reference block. The number of first relocated start positions may be equal to, or greater than, one. In some implementations, the first relocated start positions in the guided reference block may be identical to the first relocated reference positions in the guided reference block when the first relocated reference vector is the first relocated block vector. In some other implementations, the spatial relationship between the first relocated start positions and a guided collocated block may be identical to the spatial relationship between the first relocated reference positions and the guided reference block when the first relocated reference vector is the first relocated motion vector. In addition, the guided collocated block may be included in a reference frame, different from the image frame, and collocated with the block unit in the image frame.

In some implementations, the center position of the guided reference block may be predefined, as the starting point of the first relocated reference vector when the first relocated reference vector is the first relocated block vector. In some other implementations, the center position of the guided collocated block may be predefined, as the starting point of the first relocated reference vector, when the first relocated reference vector is the first relocated motion vector. In yet some other implementations, the starting point of the first relocated reference vector may be different from the center position of the guided reference block and the center position of the guided collocated block.

In some implementations, a specific one of the first relocated start positions, which is selected as the starting point of the first relocated reference vector, may be identical to, or collocated with, a specific one of the first relocated reference positions in the guided reference block. The specific first relocated reference position in the guided reference block may be covered by a specific relocated unit of the first relocated reference units, which has the first relocated reference vector. For example, the specific first relocated start position, used as the starting point of the first relocated reference vector, may be identical to, or collocated with, the third relocated position in the guided reference block. Thus, the third relocated unit, covering the third relocated position in the guided reference block, may be reconstructed by using the first relocated reference vector.

In some implementations, a method for determining the spatial relationship, between the first relocated reference block and the first relocated end position of the first relocated reference vector, may be predefined in the first electronic device 110 and/or the second electronic device 120. For example, the first relocated end position of the first relocated reference vector may be predefined at the center position of first relocated reference block.

A size of the first relocated reference block may be identical to the size Wb×Hb of the block unit. The first relocated reference block may be determined based on the size Wb×Hb of the block unit and the spatial relationship between the first relocated reference block and the first relocated end position of the first relocated reference vector. Thus, the first relocated reference block may be determined based on the center position of the first relocated reference block and the size Wb×Hb of the block unit.

In some implementations, the first relocated end position of the first relocated reference vector may be first determined based on the first relocated block vector and the first relocated start position of the first relocated block vector. The first relocated reference block may then be determined by uniformly extending a block from the first relocated end position in all directions to generate an intermediate block that has the same size, as the block unit. The intermediate block, covering the first relocated end position, which is located at a center position of the intermediate block, may be regarded as the first relocated reference block.

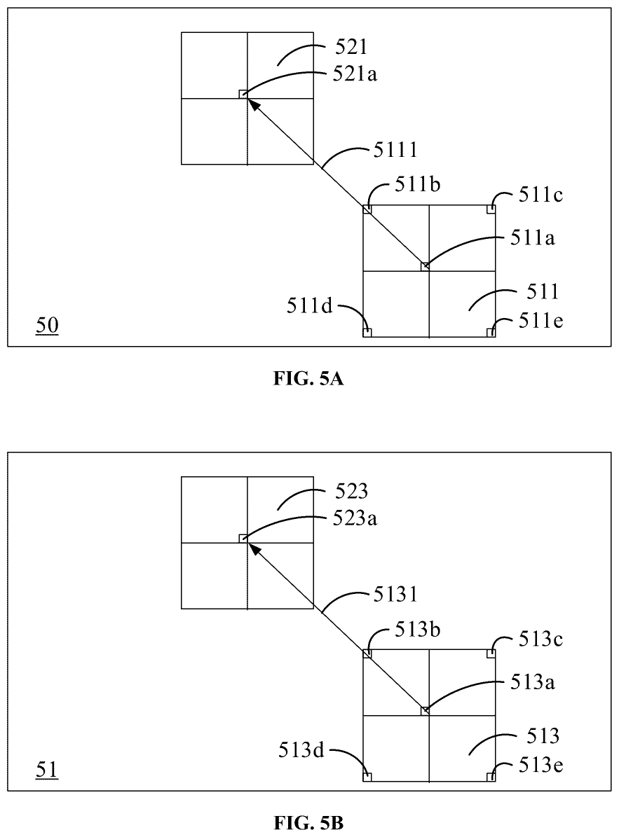

FIGS. 5A and 5B are schematic diagrams illustrating different first relocated reference blocks that are indicated by the first relocated reference vectors having the same magnitude and starting from different first relocated start positions, in accordance with one or more example implementations of this disclosure.

FIG. 5A is a schematic diagram illustrating a first relocated reference block 521 that is indicated by a first relocated block vector 5111, in accordance with one or more example implementations of this disclosure. The guided reference block 511, included in an image frame in FIG. 5A, may cover a first relocated reference position 511a, a second relocated reference position 511b, a third relocated reference position 511c, a fourth relocated reference position 511d, and a fifth relocated reference position 511e.

In some implementations, the guided reference block 511 may further cover five relocated start positions. In some implementations, the five relocated start positions may be identical to the first to fifth relocated reference positions 511a-511e. In order to determine the first relocated reference block 521, the decoder module 124 may select one of the relocated start positions, as a starting point of the first relocated block vector 5111. In some implementations, when the first relocated block vector 5111 in FIG. 5A is determined based on the third relocated reference unit covering the third relocated reference position 511c, one of the relocated start positions, which is identical to the third relocated reference position 511c, may be selected, as the starting point of the first relocated block vector 5111. In some other implementations, since the first relocated reference position 511a is the center position of the guided reference block 511, the first relocated reference position 511a may be predefined, as the starting point of the first relocated block vector 5111. Thus, when the decoder module 124 determines the first relocated reference block 521, the first relocated reference position 511a may be selected, as the starting point of the first relocated block vector 5111.

Since the first relocated end position is predefined to be located at the center position of the first relocated reference block, the decoder module 124 may uniformly extend a block from the first relocated end position 521a in all directions to generate the first relocated reference block 521. In addition, the first relocated reference block 521 may have the same size, as the guided reference block 511.

FIG. 5B is a schematic diagram illustrating a first relocated reference block 523 that is indicated by a first relocated motion vector 5131, in accordance with one or more example implementations of this disclosure. Referring to FIGS. 5A and 5B, in some implementations, a guided collocated block 513, included in a reference frame 51 in FIG. 5B and collocated with the guided reference block 511 in FIG. 5A, may cover a first relocated start position 513a, a second relocated start position 513b, a third relocated start position 513c, a fourth relocated start position 513d, and a fifth relocated start position 513e. In some implementations, the five relocated start position 513a-513e in FIG. 5B may be, respectively, collocated with the first to fifth relocated reference positions 511a-511e in FIG. 5A. In addition, the five relocated start positions 513a-513e in FIG. 5B may also be, respectively, collocated with the five relocated start positions.

In order to determine the first relocated reference block 523, the decoder module 124 may select one of the relocated start positions 513a-513e, as a starting point of the first relocated motion vector 5131. In some implementations, when the first relocated motion vector 5131 in FIG. 5B is determined based on the third relocated reference unit covering the third relocated reference position 511c, the third relocated start position 513c, collocated with the third relocated reference position 511c, may be selected, as the starting point of the first relocated motion vector 5131. In some other implementations, since the first relocated reference position 513a is the center position of the guided collocated block 513, the first relocated reference position 513a may be predefined, as the starting point of the first relocated motion vector 5131. Thus, when the decoder module 124 determines the first relocated reference block 523, the first relocated reference position 513a may be selected, as the starting point of the first relocated motion vector 5131.

Since the first relocated end position is predefined to be located at the center position of the first relocated reference block, the decoder module 124 may uniformly extend a block from the first relocated end position 523a in all directions to generate the first relocated reference block 523. In addition, the first relocated reference block 523 may have the same size, as the guided reference block 511.

In some implementations, the magnitude of the first relocated block vector 5111 may be identical to the magnitude of the first relocated motion vector 5131. However, since the first relocated reference blocks 521 and 523 are included in different frames, the first relocated reference blocks 521 in the image frame 50 may be different from the first relocated reference block 523 in the reference frame 51. In some other implementations, the magnitude of the first relocated block vector 5111 may be different from the magnitude of the first relocated motion vector 5131.

The decoder module 124 may further determine one or more relocated reference units, each of which may be associated with the first relocated reference block. Each of the one or more relocated reference units, that is associated with the first relocated reference block, may be partly, or fully, covered by the first relocated reference block.

The decoder module 124 may determine multiple relocated reference positions in the first relocated reference block. The spatial relationship between the first relocated reference block and the relocated reference positions within the first relocated reference block may be identical to the spatial relationship between the guided reference block and the relocated reference positions within the guided reference block. For example, when the coordinates of the first relocated reference block in the image frame is (c, d), the coordinates of the five relocated reference positions may, respectively, be C3 (c+((Wb−1)/2), d+((Hb−1)/2)), AL3 (c, d), AR3 (c+Wb−1, d), BL3 (c, d+Hb−1), and BR3 (c+Wb−1, d+Hb−1). In some other implementations, the coordinates of the five relocated reference positions may, respectively, be C3 (c+(Wb/2), d+(Hb/2)), AL3 (c, d), AR3 (c+Wb−1, d), BL3 (c, d+Hb−1), and BR3 (c+Wb−1, d+Hb−1).

In some implementations, a search order of the relocated reference positions in the first relocated reference block for determining a third relocated intra prediction mode may be predefined in the first electronic device 110 and/or the second electronic device 120. For example, when the number of relocated reference positions in the first relocated reference block is equal to five, the five relocated reference positions in the first relocated reference block may be sequentially ordered from the first relocated reference position to the fifth relocated reference position. In other words, the search order of the relocated reference positions in the first relocated reference block for determining the third relocated intra prediction mode may be sequentially arranged as C3, AL3, AR3, BL3, and BR3.

Since the one or more relocated reference units, associated with the first relocated reference block, are reconstructed prior to the reconstruction of the block unit, the decoder module 124 may determine one or more second relocated prediction modes of the one or more relocated reference units. Each of the one or more second relocated prediction modes may be one of an intraTMP mode, an IBC mode, an SGPM mode, one of multiple intra default modes, and an inter prediction mode.

The decoder module 124 may determine the third relocated intra prediction mode based on the one or more relocated reference units, associated with the first relocated reference block.

When a first relocated unit of the relocated reference units, which covers one or more of the relocated reference positions of the first relocated reference block, is predicted and/or reconstructed by using a third specific one of the intra default modes, the third specific intra default mode may be set, as the third relocated intra prediction mode. The one or more of relocated reference positions, of the first relocated reference block, that correspond to the first relocated unit, may include a first relocated position of the first relocated reference block. Thus, the third relocated intra prediction mode may be determined based on the first relocated position of the first relocated reference block. The third relocated intra prediction mode of the first relocated unit may be used to predict the block unit.

In some implementations, when the third specific intra default mode is identical to one of the first and second specific intra default modes, the third specific intra default mode may not be set, as the third relocated intra prediction mode. In addition, when the third specific intra default mode is different from the first and second specific intra default modes, the third specific intra default mode may be set, as the third relocated intra prediction mode. In some other implementations, when the third specific intra default mode is identical to, or different from, the first and second specific intra default modes, the third specific intra default mode may be set, as the third relocated intra prediction mode.

When a second relocated unit of the relocated reference units, which covers a second relocated position of the relocated reference positions in the first relocated reference block, is predicted and/or reconstructed by using one of the block vector prediction mode or the motion vector prediction mode, the second relocated unit may be reconstructed by using a second relocated reference vector. Thus, the second relocated reference vector may be determined based on the second relocated position that is associated with the first relocated reference block. The second relocated reference vector may be used to determine a second relocated reference block that is indicated by the second relocated block vector that starts from the first relocated reference block.

The decoder module 124 may further determine an N-th relocated reference vector based on a relocated reference position of an (N−1)-th relocated reference block. In addition, the decoder module 124 may determine an N-th relocated reference block that is indicated by the N-th relocated reference vector, of a relocated reference unit of the (N−1)-th relocated reference block, that starts from a (N−1)-th relocated start position in the (N−1)-th relocated reference block to another (N−1)-th relocated end position. The method for determining the (N−1)-th relocated start position in the (N−1)-th relocated reference block may be predefined in the first electronic device 110 and/or the second electronic device 120. In some implementations, the number N may be a relocated level of the N-th relocated reference block. In some implementations, the number N may be an integer, equal to, or greater than, zero. In some implementations, the relocated level of the guided reference block may be equal to zero, and the relocated level of the first relocated reference block may be equal to one.

When the decoder module 124 determines the N-th relocated reference block, the decoder module 124 may select one of multiple (N−1)-th relocated start positions in the (N−1)-th relocated reference block as a starting point of the N-th relocated reference vector to indicate the N-th relocated reference block. The number of (N−1)-th relocated start positions in the (N−1)-th relocated reference block may be equal to, or greater than, one. In some implementations, the (N−1)-th relocated start positions in the (N−1)-th relocated reference block may be identical to the relocated reference positions in the (N−1)-th relocated reference block.

In some implementations, a specific one of the (N−1)-th relocated start positions, which is selected as the starting point of the N-th relocated reference vector, may be identical to a specific one of the relocated reference positions in the (N−1)-th relocated reference block. The specific (N−1)-th relocated reference position in the (N−1)-th relocated reference block may be covered by a specific one of the relocated reference units, which has the N-th relocated reference vector. Thus, the specific (N−1)-th relocated start position, used as the starting point of the N-th relocated reference vector, may be identical to the specific (N−1)-th relocated reference position in the (N−1)-th relocated reference block. In addition, the specific relocated reference unit, covering the (N−1)-th relocated position in the (N−1)-th relocated reference block, may be reconstructed by using the N-th relocated reference vector.

In some implementations, the center position of the (N−1)-th relocated reference block may be predefined, as the starting point of the N-th relocated reference vector, when the N-th relocated reference vector is the N-th relocated block vector. In some other implementations, the center position of an (N−1)-th collocated reference block, collocated with the (N−1)-th relocated reference block, may be predefined, as the starting point of the N-th relocated reference vector, when the N-th relocated reference vector is the N-th relocated motion vector.

In some implementations, the (N−1)-th relocated end position of the N-th relocated reference vector may be predefined, as a center position of the N-th relocated reference block. Thus, the N-th relocated reference block may be determined based on the center position of the N-th relocated reference block and the size Wb×Hb of the block unit.

The (N−1)-th relocated end position of the N-th relocated reference vector may be first determined based on the N-th relocated reference vector and the (N−1)-th relocated start position of the N-th relocated reference vector. The N-th relocated reference block may then be determined by uniformly extending a block from the (N−1)-th relocated end position in all directions to generate an intermediate block that has the same size, as the block unit. The intermediate block, covering the (N−1)-th relocated end position, which is located at a center position of the intermediate block, may be regarded as the N-th relocated reference block.

The decoder module 124 may further determine one or more relocated reference units, each of which may be associated with the N-th relocated reference block. Each of the one or more relocated reference units that is associated with the N-th relocated reference block may be partly, or fully, covered by the N-th relocated reference block.

The decoder module 124 may determine multiple relocated reference positions in the N-th relocated reference block. The spatial relationship between the N-th relocated reference block and the relocated reference positions within the N-th relocated reference block may be identical to the spatial relationship between the (N−1)-th relocated reference block and the relocated reference positions within the (N−1)-th relocated reference block.

Since the one or more relocated reference units, associated with the N-th relocated reference block, are reconstructed prior to the reconstruction of the block unit, the decoder module 124 may determine an (N+1)-th relocated prediction modes of the one or more relocated reference units. Each of the one or more (N+1)-th relocated prediction modes may be one of an intraTMP mode, an IBC mode, an SGPM mode, one of multiple intra default modes, and an inter prediction mode.

The decoder module 124 may determine a K-th intra default mode based on one or more relocated reference units, associated with the N-th relocated reference block. In some implementations, the number K may be an integer, equal to, or greater than, one. In some implementations, the number K may be equal to, or different from, the number N.

When a first one of the one or more relocated reference units, which covers a first relocated position of the relocated reference positions in the N-th relocated reference block, is predicted and/or reconstructed by using a K-th specific one of the intra default modes, the first relocated reference unit may be reconstructed by using the K-th specific intra default mode. The K-th specific intra default mode may be determined based on the first relocated position of the N-th relocated reference block. The K-th specific intra default mode of the first relocated reference unit may be used to predict the block unit.

When a second one of the one or more relocated reference units, which covers a second relocated position of the relocated reference positions in the N-th relocated reference block, is reconstructed by using one of the block vector prediction mode or the motion vector prediction mode, the second relocated reference unit may be reconstructed by using an N-th relocated reference vector. Thus, the N-th relocated reference vector may be determined based on the second relocated reference position, associated with the N-th relocated reference block. The N-th relocated reference vector may be used to determine an (N+1)-th relocated reference block that is indicated by the N-th relocated reference vector that starts from the N-th relocated reference block.

In some implementations, the decoder module 124 may keep determining whether the one or more relocated reference units are reconstructed by using one of the block vector prediction mode or the motion vector prediction mode when the relocated level of the N-th relocated reference block equal to N is less than a relocated level threshold. In some other implementations, the decoder module 124 may forgo determining whether the one or more relocated reference units are reconstructed by using one of the block vector prediction mode or the motion vector prediction mode when the relocated level of the N-th relocated reference block equal to N is equal to the relocated level threshold. In some implementations, the relocated level threshold may be predefined in the first electronic device 110 and/or the second electronic device 120. In some implementations, the relocated level threshold may be equal to two, three, or four.

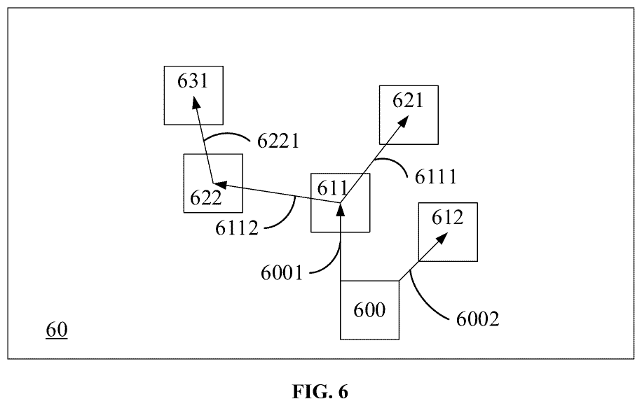

FIG. 6 is a schematic diagram illustrating multiple relocated reference blocks that are indicated by multiple relocated reference vectors and that are in different relocated levels, in accordance with one or more example implementations of this disclosure. In FIG. 6, the relocated level threshold may be equal to, or greater than, two. In some implementations, the decoder module 124 may determine the second relocated reference block without further determining the third relocated reference block. In some other implementations, the decoder module 124 may only determine the second relocated reference block since there is no relocated reference unit, covering one of multiple relocated reference positions in the second relocated reference block and reconstructed by using one of the block vector prediction mode and the motion vector prediction mode

The decoder module 124 may search for the guiding reference vectors for the block unit 600. In FIG. 6, the decoder module 124 may determine two different guiding reference vectors 6001 and 6002 for the block unit 600.

The guided candidate block 611 may be indicated by the guiding reference vector 6001 that starts from the top-left corner of the block unit 600 to the center position of the guided candidate block 611. The decoder module 124 may then search for the relocated intra prediction modes based on the relocated reference positions in the guided candidate block 611. In addition, the decoder module 124 may also search for one or more first relocated reference vectors based on the relocated reference positions in the guided candidate block 611. In FIG. 6, the decoder module 124 may determine two first relocated reference vectors 6111 and 6112.

The first relocated reference block 621 may be indicated by the first relocated reference vector 6111 that starts from the center position of the guided candidate block 611 to the center position of the first relocated reference block 621. The decoder module 124 may then search for the relocated intra prediction modes based on the relocated reference positions in the first relocated reference block 621. In addition, the decoder module 124 may also search for one or more second relocated reference vectors based on the relocated reference positions in the first relocated reference block 621. In FIG. 6, the decoder module 124 may determine no second relocated reference vector based on the relocated reference positions of the first relocated reference block 621.

The first relocated reference block 622 may be indicated by the first relocated reference vector 6112 that starts from the center position of the guided candidate block 611 to the center position of the first relocated reference block 622. The decoder module 124 may then search for the relocated intra prediction modes based on the relocated reference positions in the first relocated reference block 622. In addition, the decoder module 124 may also search for one or more second relocated reference vectors based on the relocated reference positions in the first relocated reference block 622. In FIG. 6, the decoder module 124 may determine a second relocated reference vector 6221.

The second relocated reference block 631 may be indicated by the second relocated reference vector 6221 that starts from the center position of the first relocated reference block 622 to the center position of the second relocated reference block 631. The decoder module 124 may then search for the relocated intra prediction modes based on the relocated reference positions in the second relocated reference block 631. In some implementations, the decoder module 124 may also search for one or more third relocated reference vectors based on the relocated reference positions in the second relocated reference block 631. In FIG. 6, the decoder module 124 may determine no third relocated reference vector based on the relocated reference positions of the second relocated reference block 631. In some other implementations, the decoder module 124 may not further search for the third relocated reference vector based on the relocated reference positions in the third relocated reference block 621 when the relocated level threshold is equal to two.

In some implementations, after a search loop of searching for the relocated intra prediction modes based on the top-left corner of the block unit 600 ends, the decoder module 124 may start to search for the relocated intra prediction modes based on the top-right corner of the block unit 600. The guided candidate block 612 may be indicated by the guiding reference vector 6002 that starts from the top-right corner of the block unit 600 to the center position of the guided candidate block 612. The decoder module 124 may then search for the relocated intra prediction modes based on the relocated reference positions in the guided candidate block 612. In addition, the decoder module 124 may also search for the first relocated reference vector based on the relocated reference positions in the guided candidate block 612. In FIG. 6, the decoder module 124 may determine no first relocated reference vector based on the relocated reference positions of the guided candidate block 612.

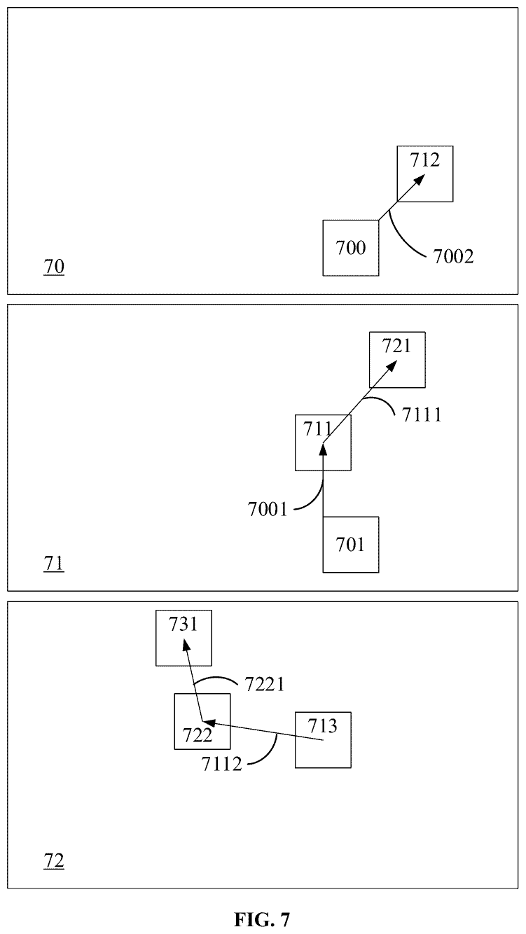

FIG. 7 is another schematic diagram illustrating multiple relocated reference blocks that are indicated by multiple relocated reference vectors and that are in different relocated levels, in accordance with one or more example implementations of this disclosure. In FIG. 7, the relocated level threshold may also be equal to, or greater than, two. In some implementations, each of the relocated reference vectors may be one of a relocated block vector or a relocated motion vector. Thus, the relocated reference blocks may be included in the image frame 70 or other reference frames, e.g., two reference frames 71 and 72.

The decoder module 124 may search for the guiding reference vectors for the block unit 700. In FIG. 7, the decoder module 124 may determine a guiding motion vector 7001 and a guiding block vector 7002 for the block unit 700.

The guided candidate block 711 may be indicated by the guiding motion vector 7001 that starts from the top-left corner of a collocated block 701, included in the reference frame 71 and collocated with the block unit 700, to the center position of the guided candidate block 711. The decoder module 124 may then search for the relocated intra prediction modes based on the relocated reference positions in the guided candidate block 711. In addition, the decoder module 124 may also search for one or more first relocated reference vectors based on the relocated reference positions in the guided candidate block 711. In FIG. 7, the decoder module 124 may determine a first relocated block vector 7111 and a first relocated motion vector 7112.

The first relocated block 721 may be indicated by the first relocated block vector 7111 that starts from the center position of the guided candidate block 711 to the center position of the first relocated reference block 721. The decoder module 124 may then search for the relocated intra prediction modes based on the relocated reference positions in the first relocated reference block 721. In addition, the decoder module 124 may also search for one or more second relocated reference vectors based on the relocated reference positions in the first relocated reference block 721.

The first relocated reference block 722 may be indicated by the first relocated motion vector 7112 that starts from the center position of a guided collocated block 713, included in the reference frame 72 and collocated with the guided candidate block 711, to the center position of the first relocated reference block 722. The decoder module 124 may then search for the relocated intra prediction modes based on the relocated reference positions in the first relocated reference block 722. In addition, the decoder module 124 may also search for one or more second relocated reference vectors based on the relocated reference positions in the first relocated reference block 722. In FIG. 7, the decoder module 124 may determine a second relocated reference vector 7221, which is a second relocated block vector.

The second relocated reference block 731 may be indicated by the second relocated reference vector 7221 that starts from the center position of the first relocated reference block 722 to the center position of the second relocated reference block 731. The decoder module 124 may then search for the relocated intra prediction modes based on the relocated reference positions in the second relocated reference block 731. In some implementations, the decoder module 124 may also search for one ore more third relocated reference vectors based on the relocated reference positions in the second relocated reference block 731.

In some implementations, after a search loop of searching for the relocated intra prediction modes based on the top-left corner of the block unit 700 ends, the decoder module 124 may start to search for the relocated intra prediction modes based on the top-right corner of the block unit 700. The guided candidate block 712 may be indicated by the guiding reference vector 7002 that starts from the top-right corner of the block unit 700 to the center position of the guided candidate block 712. The decoder module 124 may then search for the relocated intra prediction modes based on the relocated reference positions in the guided candidate block 712. In addition, the decoder module 124 may also search for the first relocated reference vector based on the relocated reference positions in the guided candidate block 712.

In some implementations, each of the relocated reference vectors may be a relocated block vector. Thus, the guided reference block and the relocated reference blocks may be included in the image frame 60 in FIG. 6. In some other implementations, each of the relocated reference vectors may be a relocated block vector or a relocated motion vector. Thus, the guided reference block and the relocated reference blocks may be included in the image frame 70 and other reference frames, e.g., the reference frames 71 and 72 in FIG. 7. In yet some other implementations, each of the relocated reference vectors may be a relocated motion vector. Thus, the guided reference block and the relocated reference blocks may be included in different reference frames and excluded from the image frame 60 in FIG. 6.

Referring back to FIG. 3, at block 360, the decoder module 124 may determine the first relocated intra prediction mode, as one of multiple most probable mode (MPM) candidates in an MPM list of the block unit.

The decoder module 124 may determine the MPM list of the block unit for predicting and/or reconstructing the block unit. The MPM list may include the MPM candidates.

When the decoder module 124 determines a first and a second relocated units, respectively, reconstructed by using one of the intra default modes and covering a first or a second relocated position in the guided candidate block, the first or the second relocated unit, covering the first or the second relocated position, may be reconstructed by using the first or the second relocated intra prediction mode. The first relocated intra prediction mode of the first relocated unit and the second relocated intra prediction mode of the second relocated unit may be added into the MPM list of the block unit, as one of the MPM candidates.

In some implementations, when the relocated intra prediction mode is the Planar mode, the relocated intra prediction mode may not be added into the MPM list. In some other implementations, when the relocated intra prediction mode is the Planar mode, the relocated intra prediction mode may still be added into the MPM list. In some implementations, when the relocated intra prediction mode is the DC mode, the relocated intra prediction mode may not be added into the MPM list. In some other implementations, when the relocated intra prediction mode is the DC mode, the relocated intra prediction mode may still be added into the MPM list.

When the decoder module 124 determines a third relocated unit, reconstructed by using one of the intra default modes and covering a first relocated position in the first relocated reference block, the third relocated unit, covering the first relocated position in the first relocated reference block, may be reconstructed by using the third relocated intra prediction mode. The third relocated intra prediction mode of the third relocated unit may be added into the MPM list of the block unit, as one of the MPM candidates.

When the decoder module 124 determines a fourth relocated unit, reconstructed by using one of the intra default modes and covering a first relocated position in the N-th relocated reference block, the fourth relocated unit, covering the first relocated position in the N-th relocated reference block, may be reconstructed by using the K-th relocated intra prediction mode. The K-th relocated intra prediction mode of the fourth relocated unit may also be added into the MPM list of the block unit, as one of the MPM candidates.

The number of MPM candidates in the MPM list may be equal to, or less than, a relocated quantity threshold. In some implementations, the relocated quantity threshold may be predefined in the first electronic device 110 and/or the second electronic device 120. In some implementations, the relocated quantity threshold may be equal to twenty.

In some implementations, the decoder module 124 may keep determining whether the one or more relocated reference units are reconstructed by using the intra default modes when the number of added MPM candidates in the MPM list is still less than the relocated quantity threshold. In some other implementations, the decoder module 124 may forgo determining whether the one or more relocated reference units are reconstructed by using the intra default modes when the number of added MPM candidates in the MPM list has been equal to the relocated quantity threshold.

Referring back to FIG. 3, at block 370, the decoder module 124 may reconstruct the block unit based on the MPM list of the block unit.

With reference to FIGS. 1 and 2, in some implementations, the decoder module 124 may determine a prediction candidate list of the block unit for reconstructing the block unit. In some implementations, the prediction candidate list may include multiple prediction candidates, selected from one or more of the MPM candidates, or other prediction candidates.

The decoder module 124 may select a prediction mode from the prediction candidates to reconstruct the block unit. In some implementations, the decoder module 124 may select the prediction mode from the prediction candidates based on a prediction index. In some other implementations, the decoder module 124 may select the prediction mode from the MPM candidates by using an MPM index. Thus, the decoder module 124 may select one of the MPM candidates in the MPM list of the block unit.

In some implementations, the decoder module 124 may then predict the block unit using the selected MPM candidate based on multiple adjacent reconstructed samples adjacent to the block unit, to generate a predicted block.

The decoder module 124 may determine multiple residual components of a residual block from the bitstream for the block unit and add the residual components into the predicted block to reconstruct the block unit. The decoder module 124 may reconstruct all of the other block units in the image frame for reconstructing the image frame and the video. The method/process 300 may then end.

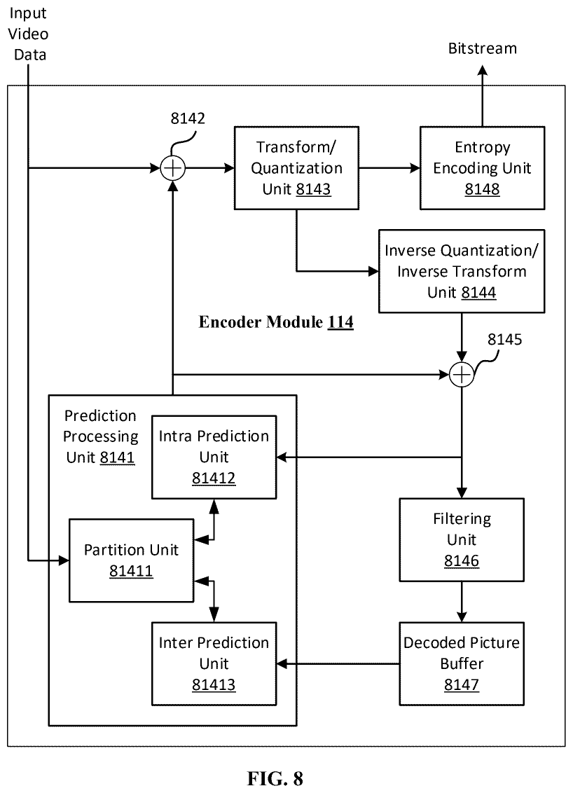

FIG. 8 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 8141), at least a first summer (e.g., a first summer 8142) and a second summer (e.g., a second summer 8145), a transform/quantization processor (e.g., a transform/quantization unit 8143), an inverse quantization/inverse transform processor (e.g., an inverse quantization/inverse transform unit 8144), a filter (e.g., a filtering unit 8146), a decoded picture buffer (e.g., a decoded picture buffer 8147), and an entropy encoder (e.g., an entropy encoding unit 8148). The prediction processing unit 8141 of the encoder module 114 may further include a partition processor (e.g., a partition unit 81411), an intra prediction processor (e.g., an intra prediction unit 81412), and an inter prediction processor (e.g., an inter prediction unit 81413). The encoder module 114 may receive the source video and encode the source video to output a bitstream.

The encoder module 114 may receive source video including multiple image frames and then divide the image frames based on a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 8141 may receive a current image block of a specific one of the image frames. The current image block may be the luminance block or one of the chrominance blocks in the specific image frame.

The partition unit 81411 may divide the current image block into multiple block units. The intra prediction unit 81412 may perform intra-predictive coding of a current block unit relative to one or more neighboring blocks in the same frame, as the current block unit, in order to provide spatial prediction. The inter prediction unit 81413 may perform inter-predictive coding of the current block unit relative to one or more blocks in one or more reference image blocks to provide temporal prediction.

The prediction processing unit 8141 may select one of the coding results generated by the intra prediction unit 81412 and the inter prediction unit 81413 based on a mode selection method, such as a cost function. The mode selection method may be a rate-distortion optimization (RDO) process.

The prediction processing unit 8141 may determine the selected coding result and provide a predicted block corresponding to the selected coding result to the first summer 8142 for generating a residual block and to the second summer 8145 for reconstructing the encoded block unit. The prediction processing unit 8141 may further provide syntax elements, such as motion vectors, intra-mode indicators, partition information, and/or other syntax information, to the entropy encoding unit 8148.

The intra prediction unit 81412 may intra-predict the current block unit. The intra prediction unit 81412 may determine an intra prediction mode directed toward a reconstructed sample neighboring the current block unit in order to encode the current block unit.

The intra prediction unit 81412 may encode the current block unit using various intra prediction modes. The intra prediction unit 81412 of the prediction processing unit 8141 may select an appropriate intra prediction mode from the selected modes. The intra prediction unit 81412 may encode the current block unit using a cross-component prediction mode to predict one of the two chroma components of the current block unit based on the luma components of the current block unit. The intra prediction unit 81412 may predict a first one of the two chroma components of the current block unit based on the second of the two chroma components of the current block unit.

The inter prediction unit 81413 may inter-predict the current block unit as an alternative to the intra prediction performed by the intra prediction unit 81412. The inter prediction unit 81413 may perform motion estimation to estimate motion of the current block unit for generating a motion vector.

The motion vector may indicate a displacement of the current block unit within the current image block relative to a reference block unit within a reference image block. The inter prediction unit 81413 may receive at least one reference image block stored in the decoded picture buffer 8147 and estimate the motion based on the received reference image blocks to generate the motion vector.

The first summer 8142 may generate the residual block by subtracting the prediction block determined by the prediction processing unit 8141 from the original current block unit. The first summer 8142 may represent the component or components that perform this subtraction.

The transform/quantization unit 8143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 8143 may perform a scan of the matrix including the quantized transform coefficients. Alternatively, the entropy encoding unit 8148 may perform the scan.

The entropy encoding unit 8148 may receive multiple syntax elements from the prediction processing unit 8141 and the transform/quantization unit 8143, including a quantization parameter, transform data, motion vectors, intra modes, partition information, and/or other syntax information. The entropy encoding unit 8148 may encode the syntax elements into the bitstream.

The entropy encoding unit 8148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 8144 may apply inverse quantization and inverse transformation to reconstruct the residual block in the pixel domain for later use as a reference block. The second summer 8145 may add the reconstructed residual block to the prediction block provided by the prediction processing unit 8141 in order to produce a reconstructed block for storage in the decoded picture buffer 8147.

The filtering unit 8146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 8145.

The decoded picture buffer 8147 may be a reference picture memory that stores the reference block to be used by the encoder module 814 to encode video, such as in intra-coding or inter-coding modes. The decoded picture buffer 8147 may include a variety of memory devices, such as DRAM (e.g., including SDRAM), MRAM, RRAM, or other types of memory devices. The decoded picture buffer 8147 may be on-chip with other components of the encoder module 114 or off-chip relative to those components.

The method/process 300 for decoding and/or encoding video data may be performed by the first electronic device 110. With reference to FIGS. 1 and 8, at block 310, the method/process 300 may start by the encoder module 114 receiving the video data. The video data received by the encoder module 114 may be a video.

At block 320, the encoder module 114 may determine a block unit from an image frame of the video data.

With reference to FIGS. 1 and 8, the encoder module 114 may determine the image frames from the video. A current frame may be one of the image frames. The encoder module 114 may further divide the current frame to determine a block unit. In some implementations, the encoder module 114 may divide the current frame to generate multiple CTUs, and may further divide a current CTU, included in the CTUs, to generate multiple divided blocks and to determine the block unit from the divided blocks.

In some other implementations, the encoder module 114 may divide the current frame to generate multiple slices or multiple tiles, and further divide a current slice or a current tile, included in the slices or the tiles, to generate multiple CTUs. In addition, the encoder module 114 may further divide a current CTU, included in the CTUs, to generate multiple divided blocks and to determine the block unit from the divided blocks.

The size of the block unit may be Wb×Hb. In some implementations, each of the Wb and Hb may be a positive integer (e.g., four, eight, etc.) that may be the same, or different from each other.

At block 330, the encoder module 114 may determine a guiding reference vector of the block unit.

With reference to FIGS. 1 and 8, the encoder module 114 may determine the guiding reference vector based on one of a guiding block vector or a guiding motion vector of a guiding reference unit. In some implementations, the guiding reference unit may be selected from multiple adjacent guiding positions and non-adjacent guiding positions. In the implementations, the guiding reference vector of the block unit, determined by the encoder module 114, may be identical to the guiding reference vector of the block unit, determined by the decoder module 124.

Referring back to FIG. 3, at block 340, the encoder module 114 may determine a guided reference block that is indicated by the guiding reference vector, of the block unit, that starts from the block unit.

With reference to FIGS. 1 and 8, the encoder module 114 may determine the guided reference block that is indicated by the guiding reference vector, of the block unit, that starts from one of multiple guiding start positions of the block unit to one of multiple guiding end positions for determining the guided reference block. In the implementations, the guiding start positions of the block unit, determined by the encoder module 114, may be identical to the guiding start positions of the block unit, determined by the decoder module 124. In addition, the guiding end positions of the block unit, determined by the encoder module 114, may be identical to the guiding end positions of the block unit, determined by the decoder module 124.

In some implementations, a search order of the guiding start positions for determining the guided reference block may be predefined in the first electronic device 110 and/or the second electronic device 120. Thus, the search order of the guiding start positions, performed by the encoder module 114, may be identical to the search order of the guiding start positions, performed by the decoder module 124.

In some implementations, a method for determining the spatial relationship between the guiding end position and the guided reference block may be predefined in the first electronic device 110 and/or the second electronic device 120. Thus, the method for determining the spatial relationship between the guiding end position and the guided reference block, performed by the encoder module 114, may be identical to the method for determining the spatial relationship between the guiding end position and the guided reference block, performed by the decoder module 124.

The encoder module 114 may determine one or more relocated reference units, each of which may be associated with the guided reference block. Each of the one or more relocated reference units may be partly or fully covered by the guided reference block. The encoder module 114 may determine multiple relocated reference positions in the guided reference block. In some implementations, a search order of the relocated reference positions for determining a relocated intra prediction mode may be predefined in the first electronic device 110 and/or the second electronic device 120. Thus, the search order of the relocated reference positions, performed by the encoder module 114, may be identical to the search order of the relocated reference positions, performed by the decoder module 124.

Referring back to FIG. 3, at block 350, the encoder module 114 may determine a first relocated intra prediction mode based on a first relocated position of the guided reference block.

With reference to FIGS. 1 and 8, when a first one of the one or more relocated reference units, which covers a first relocated position of the relocated reference positions in the guided reference block, is predicted and reconstructed by using a first specific one of the intra default modes, the first specific intra default mode may be set, as the first relocated intra prediction mode. Thus, the first relocated intra prediction mode may be determined based on the first relocated position of the guided reference block. In addition, a second relocated intra prediction mode may be determined based on a second relocated position of the relocated reference positions in the guided reference block. The first relocated intra prediction mode of the first relocated reference unit and the second relocated intra prediction mode of the second relocated reference unit may be used to predict the block unit.

In some implementations, when the first specific intra default mode is the Planar mode or the DC mode, the first specific intra default mode may be or may not be set, as the first relocated intra prediction mode. In some implementations, when the second specific intra default mode is identical to the first specific intra default mode, the second specific intra default mode may be or may not be set, as the second relocated intra prediction mode.

When a third one of the one or more relocated reference units, which covers a third relocated position of the relocated reference positions in the guided reference block, is predicted and reconstructed by using one of a block vector prediction mode or a motion vector prediction mode, the third relocated unit may be reconstructed by using a first relocated reference vector. Thus, the first relocated reference vector may be determined based on the third relocated position of the guided reference block. The first relocated reference vector may be used to determine a first relocated reference block that is indicated by the first relocated reference vector that starts from the guided reference block. In some implementations, the block vector prediction mode may include the IBC mode, the intraTMP mode, and the SGPM mode, and the motion vector prediction mode may include the inter prediction mode of the video coding standard. The first to the third relocated reference units may be different from each other. In addition, the first to the third relocated reference positions may also be different from each other.

The encoder module 114 may further determine an N-th relocated reference vector based on a relocated reference position of an (N−1)-th relocated reference block. In addition, the encoder module 114 may determine an N-th relocated reference block that is indicated by the N-th relocated reference vector, of a relocated reference unit of the (N−1)-th relocated reference block, that starts from a (N−1)-th relocated start position in the (N−1)-th relocated reference block to another (N−1)-th relocated end position. The method for determining the (N−1)-th relocated start position in the (N−1)-th relocated reference block may be predefined in the first electronic device 110 and/or the second electronic device 120. In the implementations, the (N−1)-th relocated start position in the (N−1)-th relocated reference block, determined by the encoder module 114, may be identical to the (N−1)-th relocated start position in the (N−1)-th relocated reference block, determined by the decoder module 124. In addition, the (N−1)-th relocated end position, determined by the encoder module 114, may be identical to the (N−1)-th relocated end position, determined by the decoder module 124. In some implementations, the number N may be a relocated level of the N-th relocated reference block. In some implementations, the number N may be a positive integer, equal to, or greater than, two.

The (N−1)-th relocated end position of the N-th relocated reference vector may be first determined based on the N-th relocated reference vector and the (N−1)-th relocated start position of the N-th relocated reference vector. The N-th relocated reference block may then be determined by uniformly extending a block from the (N−1)-th relocated end position in all directions to generate an intermediate block that has the same size, as the block unit. The intermediate block, covering the (N−1)-th relocated end position, which is located at a center position of the intermediate block, may be regarded as the N-th relocated reference block. In the implementations, the N-th relocated reference block, determined by the encoder module 114, may be identical to the N-th relocated reference block, determined by the decoder module 124.

The encoder module 114 may determine a K-th relocated intra prediction mode based on the one or more relocated reference units, associated with the N-th relocated reference block. In the implementations, the K-th relocated intra prediction mode, determined by the encoder module 114, may be identical to the K-th relocated intra prediction mode, determined by the decoder module 124. In some implementations, the number K may be an integer, equal to, or greater than one. In some implementations, the number K may be equal to, or different from, the number N.

In some implementations, the encoder module 114 may keep determining whether the one or more relocated reference units are reconstructed by using one of the block vector prediction mode or the motion vector prediction mode when the relocated level of the N-th relocated reference block equal to N is less than a relocated level threshold. In some other implementations, the encoder module 114 may forgo determining whether the one or more relocated reference units are reconstructed by using one of the block vector prediction mode or the motion vector prediction mode when the relocated level of the N-th relocated reference block equal to N is equal to the relocated level threshold. In some implementations, the relocated level threshold may be predefined in the first electronic device 110 and/or the second electronic device 120. In some implementations, the relocated level threshold may be equal to two, three, or four.

Referring back to FIG. 3, at block 360, the encoder module 114 may determine the first relocated intra prediction mode as one of multiple most probable mode (MPM) candidates in an MPM list of the block unit. With reference to FIGS. 1 and 8, the MPM list, determined by the encoder module 114, may be identical to the MPM list, determined by the decoder module 124.

The number of MPM candidates in the MPM list may be equal to, or less than, a relocated quantity threshold. In some implementations, the relocated quantity threshold may be predefined in the first electronic device 110 and/or the second electronic device 120. In some implementations, the relocated quantity threshold may be equal to twenty.

In some implementations, the encoder module 114 may keep determining whether the one or more relocated reference units is reconstructed by using one of the intra default modes when the number of added MPM candidates in the MPM list is still less than the relocated quantity threshold. In some other implementations, the encoder module 114 may forgo determining whether the one or more relocated reference units is reconstructed by using one of the intra default modes when the number of added MPM candidates in the MPM list has been equal to the relocated quantity threshold.

Referring back to FIG. 3, at block 370, the encoder module 114 may reconstruct the block unit based on the MPM list of the block unit.

With reference to FIGS. 1 and 8, in some implementations, the encoder module 114 may determine a prediction candidate list of the block unit for predicting and/or reconstructing the block unit.

The prediction candidate list may include multiple prediction candidates, selected from one or more of the MPM candidates, or other prediction candidates. In some implementations, the encoder module 114 may predict the block unit based on each of the prediction candidates, including the MPM candidates, to generate multiple predicted blocks.

The encoder module 114 may select one of the predicted blocks based on a mode selection method, such as a cost function. The mode selection method may be an RDO process, a Sum of Absolute Difference (SAD) process, a Sum of Absolute Transformed Difference (SATD) process, a Mean Absolute Difference (MAD) process, a Mean Squared Difference (MSD) process, or a Structural SIMilarity (SSIM) process. The encoder module 114 may provide the selected coding result to the first summer 8142 for generating a residual block and to the second summer 8145 for reconstructing the encoded block unit.

The encoder module 114 may further encode the syntax elements into a bitstream, for transmitting to the decoder module 124. The syntax elements of the block unit may be used to determine a selected prediction candidate corresponding to the selected predicted block. The syntax elements of the block unit may include at least one of an MPM flag, an MPM index, and other prediction mode index. The MPM flag may be used to indicate whether the block unit is predicted based on one of the MPM candidates. The MPM index may be used to select the prediction mode from the MPM candidates.

In some implementations, the syntax elements, associated with the block unit, may further include multiple partition indications generated based on the partitioning of the block unit (e.g., based on any video coding standard).

When a specific one of the MPM candidates is selected, the encoder module 114 may predict the block unit based on the selected MPM candidate, to generate the predicted block. The encoder module 114 may determine multiple residual components of a residual block for the block unit based on the predicted block. In addition, the encoder module 114 may add the residual components back into the predicted block to reconstruct the block unit.

The reconstruction of the block unit by the encoder module 114 may be identical to the reconstruction of the block unit by the decoder module 124. The method/process 300 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit from an image frame of the video data;
determine a guiding reference vector of the block unit;
determine a guided reference block that is indicated by the guiding reference vector of the block unit, the guiding reference vector starting from the block unit;
determine a first relocated intra prediction mode based on a first relocated position of the guided reference block, wherein the first relocated intra prediction mode is one of a plurality of most probable mode (MPM) candidates in an MPM list of the block unit; and
reconstruct the block unit based on the MPM list of the block unit.

2. The non-transitory machine-readable medium of claim 1, wherein determining the guiding reference vector of the block unit comprises:
determining a plurality of guiding reference positions of the block unit;
determining a guiding reference unit covering at least one of the plurality of guiding reference positions of the block unit; and
when the guiding reference unit is predicted based on a guiding prediction vector, determining the guiding prediction vector of the guiding reference unit as the guiding reference vector of the block unit, wherein:
when the guiding reference unit is predicted based on the image frame of the video data, the guiding prediction vector of the guiding reference unit is a guiding block vector and the guided reference block is included in the image frame, and
when the guiding reference unit is predicted based on a reference frame of the block unit, which is included in the video data and different from the image frame of the video data, the guiding prediction vector of the guiding reference unit is a guiding motion vector and the guided reference block is included in the reference frame.

3. The non-transitory machine-readable medium of claim 1, wherein determining the guided reference block that is indicated by the guiding reference vector of the block unit comprises:
determining a plurality of guiding start positions based on a block location of the block unit;
determining a guided candidate block that is indicated by the guiding reference vector of the block unit, the guiding reference vector starting from a specific one of the plurality of guiding start positions; and
when a first relocated reference unit, which covers at least one of a plurality of first relocated reference positions of the guided candidate block, is predicted based on a first specific one of a plurality of intra default modes, determining the guided candidate block as the guiding reference block of the block unit, wherein
the specific one of the plurality of intra default modes is set as the first relocated intra prediction mode and is determined as the one of the plurality of MPM candidates in the MPM list.

4. The non-transitory machine-readable medium of claim 3, wherein
when a second relocated reference unit, which covers another one of the plurality of first relocated reference positions of the guided candidate block, is predicted based on a second specific one of the plurality of intra default modes, the second specific one of the plurality of intra default modes is set as a second relocated intra prediction mode and is determined as another one of the plurality of MPM candidates in the MPM list.

5. The non-transitory machine-readable medium of claim 3, wherein the one or more computer-executable instructions, when executed by the at least one processor of the electronic device, further cause the electronic device to:
when each relocated reference unit, covering any one of the plurality of first relocated reference positions of the guided candidate block, is not predicted based on any one of the plurality of intra default modes, determine another guided candidate block that is indicated by the guiding reference vector of the block unit, the guiding reference vector starting from a next one of the plurality of guiding start positions ordered after the specific one of the plurality of guiding start positions.

6. The non-transitory machine-readable medium of claim 1, wherein the one or more computer-executable instructions, when executed by the at least one processor of the electronic device, further cause the electronic device to:
determine a first relocated reference vector based on a second relocated position of the guided reference block;
determine a first relocated reference block that is indicated by the first relocated reference vector that starts from the guided reference block;
determine a second relocated intra prediction mode based on a first relocated position of the first relocated reference block; and
determine the second relocated intra prediction mode as one of the plurality of MPM candidates in the MPM list of the block unit.

7. The non-transitory machine-readable medium of claim 1, wherein the one or more computer-executable instructions, when executed by the at least one processor of the electronic device, further cause the electronic device to:
determine an N-th relocated reference vector based on a relocated position of an (N−1)-th relocated reference block, N being an integer;
determine an N-th relocated reference block that is indicated by the N-th relocated reference vector that starts from the (N−1)-th relocated reference block, wherein the number N indicates a relocated level of the N-th relocated reference block;
determine at least one relocated reference unit of the N-th relocated reference block;
determine whether the at least one relocated reference unit of the N-th relocated reference block is reconstructed by a specific one of a plurality of intra default modes for adding into the MPM list of the block unit; and
forgo determining whether the at least one relocated reference unit of the N-th relocated reference block is reconstructed by a vector prediction mode when the relocated level of the N-th relocated reference block equal to N is equal to a relocated level threshold.

8. An electronic device for decoding video data, the electronic device comprising:
at least one processor; and
one or more non-transitory computer-readable media coupled to the at least one processor and storing one or more computer-executable instructions that, when executed by the at least one processor, cause the electronic device to:
receive the video data;
determine a block unit from an image frame of the video data;
determine a guiding reference vector of the block unit;
determine a guided reference block that is indicated by the guiding reference vector of the block unit, the guiding reference vector starting from the block unit;
determine a first relocated intra prediction mode based on a first relocated position of the guided reference block, wherein the first relocated intra prediction mode is one of a plurality of most probable mode (MPM) candidates in an MPM list of the block unit; and
reconstruct the block unit based on the MPM list of the block unit.

9. The electronic device of claim 8, wherein determining the guided reference block that is indicated by the guiding reference vector, of the block unit comprises:
determining a plurality of guiding start positions based on a block location of the block unit;
determining a guided candidate block that is indicated by the guiding reference vector of the block unit, the guiding reference vector starting from a specific one of the plurality of guiding start positions;
when a first relocated reference unit, which covers at least one of a plurality of first relocated reference positions of the guided candidate block, is predicted based on a first specific one of a plurality of intra default modes, determining the guided candidate block as the guided reference block of the block unit, wherein
the specific one of the plurality of intra default modes is set as the first relocated intra prediction mode and is determined as the one of the plurality of MPM candidates in the MPM list.

10. The electronic device of claim 9, wherein
when a second relocated reference unit, which covers another one of the plurality of first relocated reference positions of the guided candidate block, is predicted based on a second specific one of the plurality of intra default modes, the second specific one of the plurality of intra default modes is set as a second relocated intra prediction mode and is determined as another one of the plurality of MPM candidates in the MPM list.

11. The electronic device of claim 9, wherein the one or more computer-executable instructions, when executed by at least one processor of the electronic device, further cause the electronic device to:
when each relocated reference unit, covering any one of the plurality of first relocated reference positions of the guided candidate block, is not predicted based on any one of the plurality of intra default modes, determine another guided candidate block that is indicated by the guiding reference vector of the block unit, the guiding reference vector starting from a next one of the plurality of guiding start positions ordered after the specific one of the plurality of guiding start positions.

12. The electronic device of claim 8, wherein the one or more computer-executable instructions, when executed by at least one processor of the electronic device, further cause the electronic device to:
determine a first relocated reference vector based on a second relocated position of the guided reference block;
determine a first relocated reference block that is indicated by the first relocated reference vector that starts from the guided reference block;
determine a second relocated intra prediction mode based on a first relocated position of the first relocated reference block; and
determine the second relocated intra prediction mode as one of the plurality of MPM candidates in the MPM list of the block unit.

13. The electronic device of claim 8, wherein the one or more computer-executable instructions, when executed by at least one processor of the electronic device, further cause the electronic device to:
determine an N-th relocated reference vector based on a relocated position of an (N−1)-th relocated reference block, N being an integer;
determine an N-th relocated reference block that is indicated by the N-th relocated reference vector that starts from the (N−1)-th relocated reference block, wherein the number N indicates a relocated level of the N-th relocated reference block;
determine at least one relocated reference unit of the N-th relocated reference block;
determine whether the at least one relocated reference unit of the N-th relocated reference block is reconstructed by a specific one of a plurality of intra default modes for adding into the MPM list of the block unit; and
forgo determining whether the at least one relocated reference unit of the N-th relocated reference block is reconstructed by a vector prediction mode when the relocated level of the N-th relocated reference block equal to N is equal to a relocated level threshold.

14. An electronic device for encoding video data, the electronic device comprising:
at least one processor; and
one or more non-transitory computer-readable media coupled to the at least one processor and storing one or more computer-executable instructions that, when executed by the at least one processor, cause the electronic device to:
receive the video data;
determine a block unit from an image frame of the video data;
determine a guiding reference vector of the block unit;
determine a guided reference block that is indicated by the guiding reference vector of the block unit, the guiding reference vector starting from the block unit;
determine a first relocated intra prediction mode based on a first relocated position of the guided reference block, wherein the first relocated intra prediction mode is one of a plurality of most probable mode (MPM) candidates in an MPM list of the block unit; and
reconstruct the block unit based on the MPM list of the block unit.

15. The electronic device of claim 14, wherein determining the guiding reference vector of the block unit comprises:
determining a plurality of guiding reference positions of the block unit;
determining a guiding reference unit covering at least one of the plurality of guiding reference positions of the block unit;
when the guiding reference unit is predicted based on a guiding prediction vector, determining the guiding prediction vector of the guiding reference unit as the guiding reference vector of the block unit, wherein:
when the guiding reference unit is predicted based on the image frame of the video data, the guiding prediction vector of the guiding reference unit is a guiding block vector and the guided reference block is included in the image frame, and
when the guiding reference unit is predicted based on a reference frame of the block unit, which is included in the video data and different from the image frame of the video data, the guiding prediction vector of the guiding reference unit is a guiding motion vector and the guided reference block is included in the reference frame.

16. The electronic device of claim 14, wherein determining the guided reference block that is indicated by the guiding reference vector, of the block unit comprises:
determining a plurality of guiding start positions based on a block location of the block unit;
determining a guided candidate block that is indicated by the guiding reference vector of the block unit, the guiding reference vector starting from a specific one of the plurality of guiding start positions;
when a first relocated reference unit, which covers at least one of a plurality of first relocated reference positions of the guided candidate block, is predicted based on a first specific one of a plurality of intra default modes, determining the guided candidate block as the guided reference block of the block unit, wherein
the specific one of the plurality of intra default modes is set as the first relocated intra prediction mode and is determined as the one of the plurality of MPM candidates in the MPM list.

17. The electronic device of claim 16, wherein
when a second relocated reference unit, which covers another one of the plurality of first relocated reference positions of the guided candidate block, is predicted based on a second specific one of the plurality of intra default modes, the second specific one of the plurality of intra default modes is set as a second relocated intra prediction mode and is determined as another one of the plurality of MPM candidates in the MPM list.

18. The electronic device of claim 16, wherein the one or more computer-executable instructions, when executed by at least one processor of the electronic device, further cause the electronic device to:
when each relocated reference unit, covering any one of the plurality of first relocated reference positions of the guided candidate block, is not predicted based on any one of the plurality of intra default modes, determine another guided candidate block that is indicated by the guiding reference vector of the block unit, that the guiding reference vector starting a next one of the plurality of guiding start positions ordered after the specific one of the plurality of guiding start positions.

19. The electronic device of claim 14, wherein the one or more computer-executable instructions, when executed by at least one processor of the electronic device, further cause the electronic device to:
determine a first relocated reference vector based on a second relocated position of the guided reference block;
determine a first relocated reference block that is indicated by the first relocated reference vector that starts from the guided reference block;
determine a second relocated intra prediction mode based on a first relocated position of the first relocated reference block; and
determine the second relocated intra prediction mode as one of the plurality of MPM candidates in the MPM list of the block unit.

20. The electronic device of claim 14, wherein the one or more computer-executable instructions, when executed by at least one processor of the electronic device, further cause the electronic device to:
determine an N-th relocated reference vector based on a relocated position of an (N−1)-th relocated reference block, N being an integer;
determine an N-th relocated reference block that is indicated by the N-th relocated reference vector that starts from the (N−1)-th relocated reference block, wherein the number N indicates a relocated level of the N-th relocated reference block;
determine at least one relocated reference unit of the N-th relocated reference block;
determine whether the at least one relocated reference unit of the N-th relocated reference block is reconstructed by a specific one of a plurality of intra default modes for adding into the MPM list of the block unit; and
forgo determining whether the at least one relocated reference unit of the N-th relocated reference block is reconstructed by a vector prediction mode when the relocated level of the N-th relocated reference block equal to N is equal to a relocated level threshold.
